(19) United States
(12) Patent Application Publication
(10) Pub. No.: US 2023/0092837 A1
(43) Pub. Date: Mar. 23, 2023

(54) METHODS AND APPARATUS FOR AUTOMATICALLY ADVANCING STEPS OF COOK PROGRAMS FOR GRILLS BASED ON DETECTED LID POSITION DATA

(71) Applicant: Weber-Stephen Products LLC, Palatine, IL (US)

(72) Inventors: Kevin James Glennon, Hoffman Estates, IL (US); William Alexander Mecker, Kildeer, IL (US); Mallory Evans, Chicago, IL (US)

(21) Appl. No.: 17/871,650

(22) Filed: Jul. 22, 2022

Related U.S. Application Data
(60) Provisional application No. 63/245,640, filed on Sep. 17, 2021.

(51) Int. Cl. A47J 37/07; A23L 5/10; F24C 15/02

(52) U.S. Cl. CPC A47J 37/0786; A47J 37/0713; A23L 5/15; F24C 15/02; A23V 2002/00

(57) ABSTRACT

Example methods and apparatus for automatically advancing steps of cook programs for grills based on detected lid position data are disclosed. An example grill includes a cookbox, a lid, a cooking chamber, and a controller. The lid is movable relative to the cookbox between a closed position and an open position. The cooking chamber is defined by the cookbox and the lid, and is accessible to a user of the grill when the lid is in the open position. The controller is to implement a cook program to cook an item of food within the cooking chamber. The cook program includes a plurality of ordered steps, which include a lid-opening step requiring the lid to be moved from the closed position to the open position. In response to determining, based on lid position data, that the lid-opening step has been performed, the controller is to automatically advance the plurality of ordered steps from the lid-opening step to a next step of the plurality of ordered steps.

### RELATED APPLICATIONS

This application claims priority to U.S. Provisional Patent Application No. 63/245,640, filed Sep. 17, 2021. The entirety of U.S. Provisional Patent Application No. 63/245,640 is hereby incorporated by reference herein.

### FIELD OF THE DISCLOSURE

This disclosure relates generally to cook programs for grills and, more specifically, to methods and apparatus for automatically advancing steps of cook programs for grills based on detected lid position data.

### BACKGROUND

Some known grills are equipped with a controller configured to implement various controlled cooking operations and/or steps in association with one or more selectable cook program(s). Each cook program includes a plurality of ordered steps, some of which can be performed in an automated manner at the direction of the controller (e.g., increasing or decreasing a temperature within a cooking chamber of the grill), and others of which require user (e.g., human) interaction with some aspect of the grill. For example, it is common for any cook program to include at least one step that requires a user of the grill to open a lid of the grill (e.g., to perform a “lid-opening step”). Each lid-opening step enables the user to access a cooking chamber defined by the lid and by a cookbox of the grill to which the lid is coupled. Such access may be necessary, for example, to add an item of food to the cooking chamber, to remove an item of food from the cooking chamber, or to flip, rotate, relocate, or otherwise move an item of food within the cooking chamber, any and/or all of which may be required of the user in association with the selected cook program.

In conventional implementations, each lid-opening step of a cook program is prefaced and/or accompanied by a user notification (e.g., a visible, audible, and/or tactile message or alert) that is presented either locally at the grill (e.g., via one or more output device(s) of a user interface of the grill), or at a remote device in wireless electrical communication with the grill and in the user's possession. Following the presentation of the user notification, control of the cook program remains at the associated lid-opening step until the user has submitted a confirmation input indicating that the associated lid-opening step has been performed. In such examples, the confirmation input is typically communicated by the user via one or more interaction(s) with one or more input device(s) of a user interface of the grill, and/or via one or more interaction(s) with one or more input device(s) of the remote device. Only after the grill has received the confirmation input will the controller of the grill then advance the cook program from the lid-opening step to a next step (e.g., a fully-automated step) of the cook program.

### BRIEF DESCRIPTION OF THE DRAWINGS

FIG. 1 is a block diagram of an example grill constructed in accordance with the teachings of this disclosure.

FIG. 2 is a perspective view of an example implementation of the grill of FIG. 1, with an example lid of the grill shown in an example closed position relative to an example cookbox of the grill.

FIG. 3 is a perspective view of the implementation of the grill shown in FIG. 2, with the lid of the grill shown in an example open position relative to the cookbox of the grill.

FIG. 4 is an exploded view of the implementation of the grill shown in FIGS. 2 and 3.

FIG. 5 is a perspective view of the cookbox of the implementation of the grill shown in FIGS. 2-4.

FIG. 6 a front view of an example implementation of the user interface of FIG. 1.

FIG. 7 is a logical representation of an example cook program to be implemented by the grill of FIG. 1.

FIG. 8 is a flowchart representative of example machine-readable instructions and/or example operations that may be executed by processor circuitry to implement the grill of FIG. 1.

FIG. 9 is a block diagram of an example processor platform including processor circuitry structured to execute and/or instantiate the machine-readable instructions and/or operations of FIG. 8 to implement the grill of FIG. 1.

FIG. 10 is a block diagram of an example implementation of the processor circuitry of FIG. 9.

FIG. 11 is a block diagram of another example implementation of the processor circuitry of FIG. 9.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Some known grills are equipped with a controller configured to implement various controlled cooking operations and/or steps in association with one or more selectable cook program(s). Each cook program includes a plurality of ordered steps, some of which can be performed in an automated manner at the direction of the controller (e.g., increasing or decreasing a temperature within a cooking chamber of the grill), and others of which require user (e.g., human) interaction with some aspect of the grill. For example, it is common for any cook program to include at least one step that requires a user of the grill to open a lid of the grill (e.g., to perform a “lid-opening step”). Each lid-opening step enables the user to access a cooking chamber defined by the lid and by a cookbox of the grill to which the lid is coupled. Such access may be necessary, for example, to add an item of food to the cooking chamber, to remove an item of food from the cooking chamber, or to flip, rotate, relocate, or otherwise move an item of food within the cooking chamber, any and/or all of which may be required of the user in association with the selected cook program.

In conventional implementations, each lid-opening step of a cook program is prefaced and/or accompanied by a user notification (e.g., a visible, audible, and/or tactile message or alert) that is presented either locally at the grill (e.g., via one or more output device(s) of a user interface of the grill), or at a remote device in wireless electrical communication with the grill and in the user's possession. Following the presentation of the user notification, control of the cook program remains at the associated lid-opening step until the user has submitted a confirmation input indicating that the associated lid-opening step has been performed. In such examples, the confirmation input is typically communicated by the user via one or more interaction(s) with one or more input device(s) of a user interface of the grill, and/or via one or more interaction(s) with one or more input device(s) of the remote device. Only after the grill has received the confirmation input will the controller of the grill then advance the cook program from the lid-opening step to a next step (e.g., a fully-automated step) of the cook program.

Although a relatively simple task, submission of the above-described confirmation input nonetheless must be manually performed by a user of the grill in order for the cook program to advance from the lid-opening step to the next step (e.g., a fully-automated step) of the cook program. Instances may arise whereby the user manually performs the lid-opening step in response to the presented user notification, but thereafter fails to submit the associated confirmation input. When such instances arise, the cook program fails to progress and/or advance as intended by the user, which may negatively impact the overall quality of the cooking experience associated with preparing an item of food utilizing the cook program. Furthermore, in cook programs that require a plurality of lid-opening steps, the user may find that the recurring need to submit confirmation inputs detracts from the overall user experience associated with preparing an item of food utilizing the cook program.

Relative to the known cook program implementations described above that require user submission of a confirmation input in order to advance a cook program from a lid-opening step of the cook program to a next step (e.g., a fully-automated step) of the cook program, the methods and apparatus disclosed herein advantageously automatically advance a cook program from a lid-opening step to a next step (e.g., a fully-automated step) based on detected lid position data indicating that a lid of a grill implementing the cook program has moved from a closed position to or toward an open position. In some examples, the lid position data is sensed, measured, and/or detected via a lid position sensor of the grill. In other examples, the lid position data is derived from temperature data that is sensed, measured, and/or detected via a temperature sensor of the grill. Implementation of the disclosed methods and apparatus for automatically advancing a cook program from a lid-opening step to a next step (e.g., a fully-automated step) advantageously makes the cook program less cumbersome in terms of the extent of user involvement required by the cook program, thereby reducing instances of user error associated with the submission of confirmation inputs that are required of known cook program implementations. The disclosed methods and apparatus accordingly improve the overall quality of the cooking experience associated with preparing an item of food utilizing a cook program, and also provide a user experience that is improved relative to that provided by known cook program implementations.

The above-identified features as well as other advantageous features of example methods and apparatus for automatically advancing steps of cook programs for grills based on detected lid position data as disclosed herein are further described below in connection with the figures of the application. As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation. As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

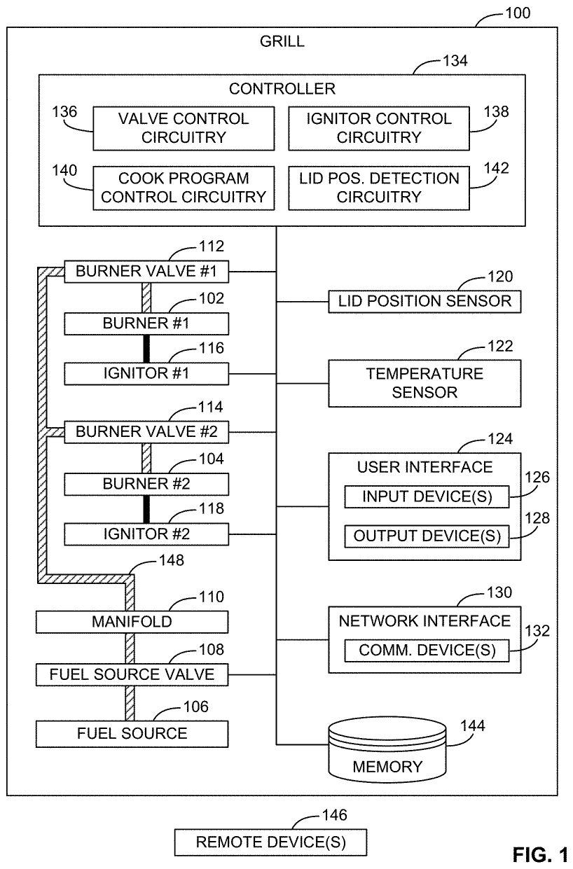

FIG. 1 is a block diagram of an example grill 100 constructed in accordance with the teachings of this disclosure. The grill 100 of FIG. 1 is a gas grill including a plurality of burners. In other examples, the grill 100 can be implemented as a different type of grill having a controllable heat source (e.g., a pellet grill, an electric grill, etc.). In the illustrated example of FIG. 1, the grill 100 includes an example first burner 102 and an example second burner 104. In other examples, the grill 100 can include one or more other burner(s) (e.g., a third burner, a fourth burner, a fifth burner, etc.) in addition to the first burner 102 and the second burner 104 shown and described in connection with FIG. 1. The first burner 102 and the second burner 104 of FIG. 1 are each constructed as a burner tube (e.g., a linear burner tube) including a gas inlet for receiving a flow of combustible gas, and further including a plurality of apertures configured to emit flames generated in response to ignition of the gas flowing into and/or through the burner tube.

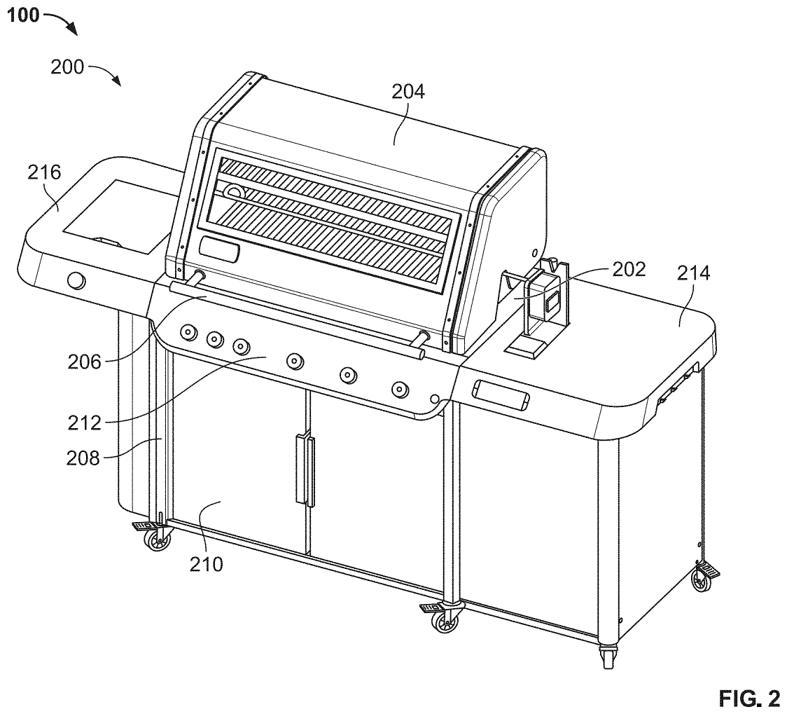

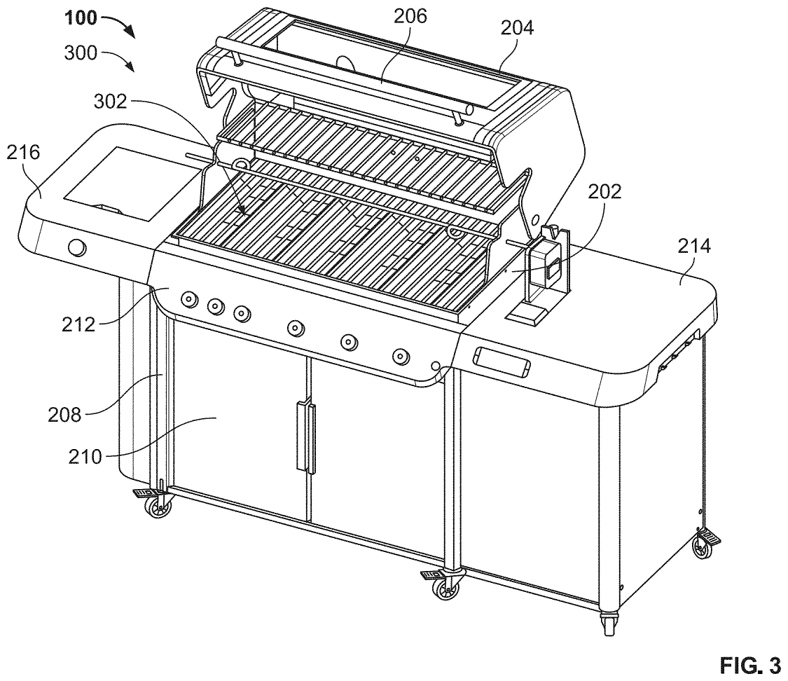

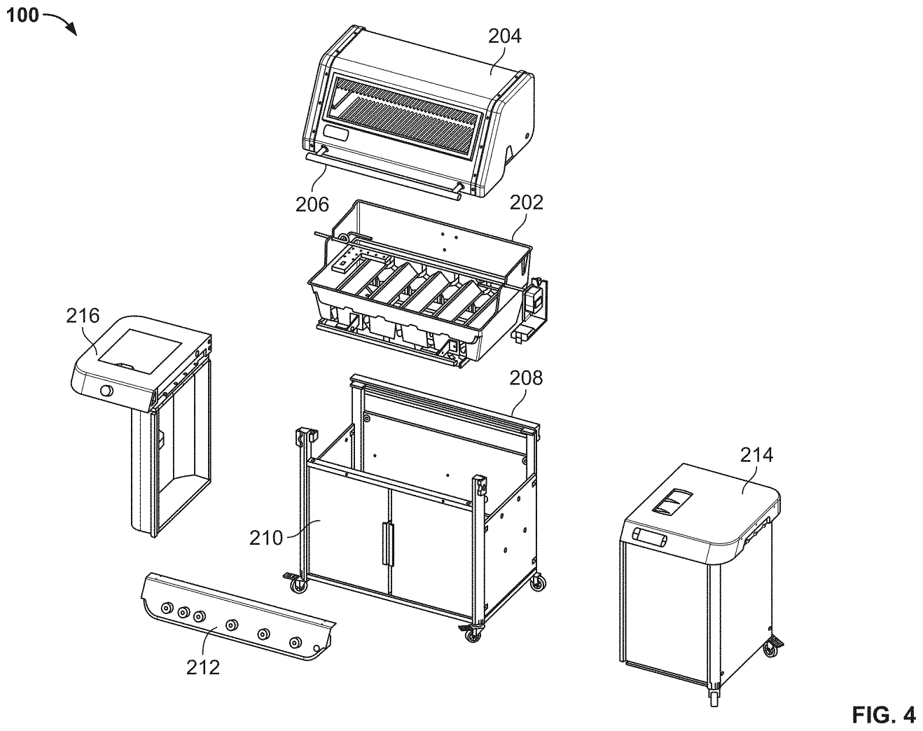

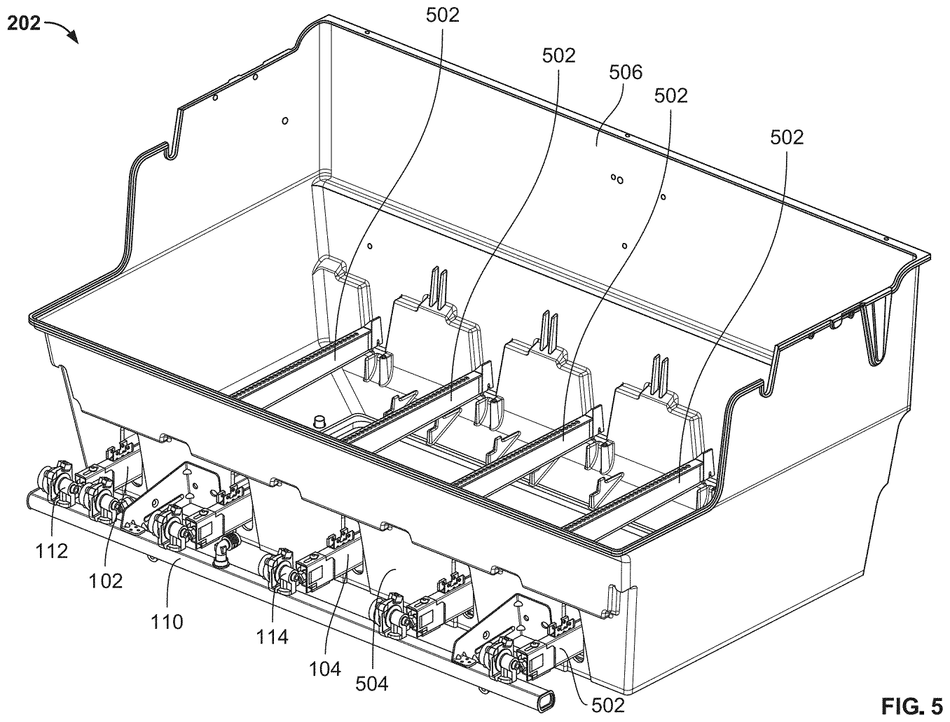

FIG. 2 is a perspective view of an example implementation of the grill 100 of FIG. 1, with an example lid 204 of the grill 100 shown in an example closed position 200 relative to an example cookbox 202 of the grill 100. FIG. 3 is a perspective view of the implementation of the grill 100 shown in FIG. 2, with the lid 204 of the grill 100 shown in an example open position 300 relative to the cookbox 202 of the grill 100. FIG. 4 is an exploded view of the implementation of the grill 100 shown in FIGS. 2 and 3. FIG. 5 is a perspective view of the cookbox 202 of the implementation of the grill 100 shown in FIGS. 2-4.

The cookbox 202 of the grill 100 supports, carries, and/or houses the burners (e.g., the first burner 102 and the second burner 104) of the grill 100, with respective ones of the burners being spaced apart from one another within the cookbox 202. As shown in FIG. 5, the cookbox 202 supports, carries, and/or houses a total of five example burners 502 (e.g., including the first burner 102 and the second burner 104 of FIG. 1), with each of the five burners 502 being spaced apart from one another within the cookbox 202. In other examples, the cookbox 202 can support, carry, and/or house a different number (e.g., two, three, four, six, etc.) of burners 502. In the illustrated example of FIGS. 2-5, each of the burners 502 is constructed as a linear burner tube positioned in a front-to-rear orientation within the cookbox 202 (e.g., extending from a front wall 504 of the cookbox 202 to a rear wall 506 of the cookbox 202). In other examples, one or more of the burner(s) 502 can have a different shape (e.g., a non-linear shape such as a P-tube), and/or can have a different orientation (e.g., a left-to-right orientation) within the cookbox 202. It should accordingly be understood that the cookbox configuration shown in FIGS. 2-5 is but one example of a cookbox 202 that can be implemented as part of the grill 100 of FIG. 1.

The lid 204 of the grill 100 is configured to cover and/or enclose the cookbox 202 of the grill 100 when the lid is in a closed position (e.g., the closed position 200 of FIG. 2). In the illustrated example of FIGS. 2-4, the lid 204 is movably (e.g., pivotally) coupled to the cookbox 202 such that the lid 204 can be moved (e.g., pivoted) relative to the cookbox 202 between a closed position (e.g., the closed position 200 of FIG. 2) and an open position (e.g., the open position 300 of FIG. 3). In other examples, the lid 204 of the grill 100 can instead be removably positioned on the cookbox 202 of the grill 100 without there being any direct mechanical coupling between the lid 204 and the cookbox 202. In some such other examples, the lid 204 can be movably (e.g., pivotally) coupled to one or more structure(s) of the grill 100 other than the cookbox 202. For example, the lid 204 can be movably (e.g., pivotally) coupled to a frame, to a cabinet, and/or to one or more side table(s) of the grill 100. Movement of the lid 204 of the grill 100 between the closed position 200 shown in FIG. 2 and the open position 300 shown in FIG. 3 can be facilitated via user interaction with an example handle 206 of the grill 100 that is coupled to the lid 204.

In the illustrated example of FIGS. 2-4, the cookbox 202 and the lid 204 of the grill 100 collectively define an example cooking chamber 302 configured to cook one or more item(s) of food. The cooking chamber 302 of the grill 100 becomes accessible to a user of the grill 100 when the lid 204 of the grill 100 is in the open position 300 shown in FIG. 3. Conversely, the cooking chamber 302 of the grill 100 is generally inaccessible to the user of the grill 100 when the lid 204 of the grill 100 is in the closed position 200 shown in FIG. 2. User access to the cooking chamber 302 of the grill 100 may periodically become necessary, for example, to add an item of food to the cooking chamber 302 (e.g., at or toward the beginning of a cook program), to remove an item of food from the cooking chamber 302 (e.g., at or toward the end of a cook program), and/or to flip, rotate, relocate, or otherwise move an item of food within the cooking chamber 302 (e.g., during the middle of a cook program).

As further shown in FIGS. 2-4, the grill 100 includes an example frame 208 that supports the cookbox 202 of the grill 100. In the illustrated example of FIGS. 2-4, the frame 208 forms an example cabinet 210 within which one or more component(s) of the grill 100 can be housed and/or stored. In other examples, the cabinet 210 of the grill 100 can be omitted in favor of an open-space configuration of the frame 208. As further shown in FIGS. 2-4, the grill 100 includes an example control panel 212 located along the front portion of the cookbox 202, the frame 208, and/or the cabinet 210 of the grill 100, an example first side table 214 located on a first side (e.g., a right side) of the cookbox 202, the frame 208, and/or the cabinet 210 of the grill 100, and an example second side table 216 located on a second side (e.g., a left side) of the cookbox 202, the frame 208, and/or the cabinet 210 of the grill 100. Various components of the grill 100 of FIG. 1 described herein can be supported by, carried by, housed by, mounted to, and/or otherwise coupled to at least one of the cookbox 202, the lid 204, the handle 206, the frame 208, the cabinet 210, the control panel 212, the first side table 214, and/or the second side table 216 of the grill 100.

Returning to the illustrated example of FIG. 1, the grill 100 of FIG. 1 further includes an example fuel source 106, an example fuel source valve 108, an example manifold 110, an example first burner valve 112, an example second burner valve 114, an example first ignitor 116, an example second ignitor 118, an example lid position sensor 120, an example temperature sensor 122, an example user interface 124 (e.g., including one or more example input device(s) 126 and one or more example output device(s) 128), an example network interface 130 (e.g., including one or more example communication device(s) 132), an example controller 134 (e.g., including example valve control circuitry 136, example ignitor control circuitry 138, example cook program control circuitry 140, and example lid position detection circuitry 142), and an example memory 144. The grill 100 of FIG. 1 is configured to communicate (e.g., wirelessly communicate) with one or more example remote device(s) 146, as further described below.

The grill 100 of FIG. 1 includes a control system for implementing one or more selectable cook program(s) that respectively include various ordered steps, instructions, and/or operations by which one or more item(s) of food are to be cooked within the cooking chamber 302 of the grill 100. In the illustrated example of FIG. 1, the control system of the grill 100 includes the fuel source valve 108, the first burner valve 112, the second burner valve 114, the first ignitor 116, the second ignitor 118, the lid position sensor 120, the temperature sensor 122, the user interface 124 (e.g., including the input device(s) 126 and the output device(s) 128), the network interface 130 (e.g., including the communication device(s) 132), the controller 134 (e.g., including the valve control circuitry 136, the ignitor control circuitry 138, the cook program control circuitry 140, and the lid position detection circuitry 142), and the memory 144. In other examples, one or more of the aforementioned components of the grill 100 can be omitted from the control system of the grill 100. For example, the fuel source valve 108 can be omitted from the control system of the grill 100 in instances where the fuel source valve 108 is not configured to be electrically controlled and/or electrically actuated by the controller 134, with the fuel source valve 108 instead being configured only for manual control and/or manual actuation. In still other examples, the control system of the grill 100 can further include the remote device(s) 146 that are configured to communicate (e.g., wirelessly communicate) with the grill 100.

The control system of the grill 100 of FIG. 1 is powered and/or operated by a power source. For example, the electrical components that form the control system of the grill 100 can be powered and/or operated by DC power supplied via one or more on-board or connected batteries of the grill 100. As another example, the electrical components that form the control system of the grill 100 can alternatively be powered and/or operated by AC power supplied via household electricity or wall power to which the grill 100 is connected. The grill 100 includes a power button (e.g., a power switch) that is configured to enable (e.g., power on) or disable (e.g., power off) the control system of the grill 100 in response to the power button being manually actuated by a user of the grill 100.

The grill 100 of FIG. 1 further includes an example gas train 148 that extends from the fuel source 106 to the manifold 110 of the grill 100, and from the manifold 110 to respective ones of the first burner 102 and the second burner 104 of the grill 100. The gas train 148 can be implemented via one ore more conduit(s) (e.g., one or more rigid or flexible pipe(s), tube(s), etc.) that are configured to carry combustible gas from the fuel source 106 to the first burner 102 and/or the second burner 104 of the grill 100. In some examples, the fuel source 106 is implemented as a fuel tank (e.g., a propane tank) containing combustible gas. In such examples, the fuel source 106 will typically be located partially or fully within the cabinet 210 of the grill 100, partially or fully within a spatial footprint formed by the frame 208 of the grill 100, below the cookbox 202 of the grill 100 and partially or fully within a spatial footprint formed by the cookbox 202 of the grill 100, or below the cookbox 202 of the grill 100 and partially or fully within a spatial footprint formed by the first side table 214 or the second side table 216 of the grill 100. In other examples, the fuel source 106 can instead be implemented as a piped (e.g., household) natural gas line that provides an accessible flow of combustible gas.

The fuel source valve 108 of FIG. 1 is coupled to and operatively positioned within the gas train 148 between the fuel source 106 and the manifold 110 of the grill 100. The fuel source valve 108 is configured to be movable between a closed position that prevents gas contained within the fuel source 106 from flowing into the manifold 110, and an open position that enables gas contained within the fuel source 106 to flow from the fuel source 106 into the manifold 110. In the illustrated example of FIG. 1, the fuel source valve 108 is operatively coupled to (e.g., in electrical communication with) the controller 134 of the grill 100, with the fuel source valve 108 being implemented as a controllable electric valve (e.g., a solenoid valve) that is configured to transition from the closed position to the open position, and vice-versa, in response to instructions, commands, and/or signals (e.g., a supply of current) generated by the controller 134. In other examples, the fuel source valve 108 can instead be implemented as a valve having a knob or a lever operatively coupled (e.g., mechanically coupled) thereto, with the knob or the lever being configured to be electrically actuated (e.g., via a motor) in response to instructions, commands, and/or signals generated by the controller 134 of the grill 100. In still other examples, the fuel source valve 108 may have no electrically-controllable components, in which case actuation of the fuel source valve 108 from the closed position to the open position, and vice-versa, occurs in response to a user of the grill 100 manually actuating a knob or a lever that is operatively coupled (e.g., mechanically coupled) to the fuel source valve 108.

The first burner valve 112 of FIG. 1 is coupled to and operatively positioned within the gas train 148 between the manifold 110 and the first burner 102 of the grill 100. In some examples, a gas inlet of the first burner valve 112 is located within the manifold 110, and a gas outlet of the first burner valve 112 is located within the first burner 102. The first burner valve 112 is configured to be movable between a closed position that prevents gas contained within the manifold 110 from flowing into the first burner 102, and an open position that enables gas contained within the manifold 110 to flow from the manifold 110 into the first burner 102. In the illustrated example of FIG. 1, the first burner valve 112 is operatively coupled to (e.g., in electrical communication with) the controller 134 of the grill 100, with the first burner valve 112 being is implemented as a controllable electric valve (e.g., a solenoid valve) that is configured to transition from the closed position to the open position, and vice-versa, in response to instructions, commands, and/or signals (e.g., a supply of current) generated by the controller 134. In some examples, the first burner valve 112 is controllable to any position (e.g., infinite position control) between the above-described closed position (e.g., fully closed) and the above-described open position (e.g., fully open). In some examples, the first burner valve 112 of FIG. 1 is controllable to different positions between the above-described closed position (e.g., fully closed) and the above-described open position (e.g., fully open) to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

The second burner valve 114 of FIG. 1 is coupled to and operatively positioned within the gas train 148 between the manifold 110 and the second burner 104 of the grill 100. In some examples, a gas inlet of the second burner valve 114 is located within the manifold 110, and a gas outlet of the second burner valve 114 is located within the second burner 104. The second burner valve 114 is configured to be movable between a closed position that prevents gas contained within the manifold 110 from flowing into the second burner 104, and an open position that enables gas contained within the manifold 110 to flow from the manifold 110 into the second burner 104. In the illustrated example of FIG. 1, the second burner valve 114 is operatively coupled to (e.g., in electrical communication with) the controller 134 of the grill 100, with the second burner valve 114 being implemented as a controllable electric valve (e.g., a solenoid valve) that is configured to transition from the closed position to the open position, and vice-versa, in response to instructions, commands, and/or signals (e.g., a supply of current) generated by the controller 134. In some examples, the second burner valve 114 is controllable to any position (e.g., infinite position control) between the above-described closed position (e.g., fully closed) and the above-described open position (e.g., fully open). In some examples, the first burner valve 112 of FIG. 1 is controllable to different positions between the above-described closed position (e.g., fully closed) and the above-described open position (e.g., fully open) to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

The first ignitor 116 of FIG. 1 is mechanically coupled and/or operatively positioned relative to the first burner 102 of the grill 100. More specifically, the first ignitor 116 is located adjacent the first burner 102 at a position that enables the first ignitor 116 to ignite combustible gas as the gas emanates from within the first burner 102 via apertures formed in the first burner 102. The first ignitor 116 of FIG. 1 is operatively coupled to (e.g., in electrical communication with) the controller 134 of the grill 100, with the first ignitor 116 being configured to generate sparks (e.g., via a spark electrode of the first ignitor 116) and/or otherwise induces ignition of the combustible gas in response to an instruction, a command, and/or a signal generated by the controller 134.

The second ignitor 118 of FIG. 1 is mechanically coupled and/or operatively positioned relative to the second burner 104 of the grill 100. More specifically, the second ignitor 118 is located adjacent the second burner 104 at a position that enables the second ignitor 118 to ignite combustible gas as the gas emanates from within the second burner 104 via apertures formed in the second burner 104. The second ignitor 118 of FIG. 1 is operatively coupled to (e.g., in electrical communication with) the controller 134 of the grill 100, with the second ignitor 118 being configured to generate sparks (e.g., via a spark electrode of the second ignitor 118) and/or otherwise induces ignition of the combustible gas in response to an instruction, a command, and/or a signal generated by the controller 134.

In some examples, the first ignitor 116 and/or the second ignitor 118 of FIG. 1 can respectively be structured, configured, and/or implemented as one of the various ignitors described in U.S. patent application Ser. No. 17/144,038, filed on Jan. 7, 2021. In such examples, the first ignitor 116 and/or the second ignitor 118 of FIG. 1 can respectively be mechanically coupled to a corresponding one of the first burner 102 and/or the second burner 104 of the grill 100 via a ceramic harness as described in U.S. patent application Ser. No. 17/144,038. The entirety of U.S. patent application Ser. No. 17/144,038 is hereby incorporated by reference herein.

The lid position sensor 120 of FIG. 1 senses, measures, and/or detects a position (e.g., a closed position, an open position, and/or any position therebetween) and/or a change in position (e.g., movement) of the lid 204 of the grill 100. In some examples, the lid position sensor 120 can be implemented by and/or as a contact sensor (e.g., a limit switch) having one or more component(s) coupled to the cookbox 202, the lid 204, the handle 206, the frame 208, the cabinet 210, the control panel 212, the first side table 214, and/or the second side table 216 of the grill 100. In other examples, the lid position sensor 120 can alternatively be implemented by and/or as a proximity sensor (e.g., a proximity switch) having one or more component(s) coupled to the cookbox 202, the lid 204, the handle 206, the frame 208, the cabinet 210, the control panel 212, the first side table 214, and/or the second side table 216 of the grill 100. In still other examples, the lid position sensor 120 can alternatively be implemented by and/or as an accelerometer having one or more component(s) coupled to the lid 204 or the handle 206 of the grill 100. In still other examples, the lid position sensor 120 can alternatively be implemented by and/or as an optical sensor (e.g., an optical switch) having one or more component(s) coupled to the cookbox 202, the lid 204, the handle 206, the frame 208, the cabinet 210, the control panel 212, the first side table 214, and/or the second side table 216 of the grill 100. In still other examples, the lid position sensor 120 can alternatively be implemented by and/or as a Bowden cable connected switch having one or more component(s) coupled to the cookbox 202, the lid 204, the handle 206, the frame 208, the cabinet 210, the control panel 212, the first side table 214, and/or the second side table 216 of the grill 100. Data, information, and/or signals sensed, measured, and/or detected by the lid position sensor 120 of FIG. 1 can be of any quantity, type, form, and/or format. Data, information, and/or signals sensed, measured, and/or detected by the lid position sensor 120 of FIG. 1 can be transmitted directly to the controller 134 of FIG. 1, and/or can be transmitted to and stored in the memory 144 of FIG. 1.

The temperature sensor 122 of FIG. 1 senses, measures, and/or detects the temperature within the cooking chamber 302 of the grill 100. In some examples, the temperature sensor 122 can be implemented by and/or as a thermocouple coupled to either the cookbox 202 or the lid 204 of the grill 100, and positioned in and/or extending into the cooking chamber 302 of the grill 100. Data, information, and/or signals sensed, measured, and/or detected by the temperature sensor 122 of FIG. 1 can be of any quantity, type, form, and/or format. Data, information, and/or signals sensed, measured, and/or detected by the temperature sensor 122 of FIG. 1 can be transmitted directly to the controller 134 of FIG. 1, and/or can be transmitted to and stored in the memory 144 of FIG. 1.

The user interface 124 of FIG. 1 includes one or more input device(s) 126 (e.g., buttons, dials, knobs, switches, touchscreens, etc.) and/or one or more output device(s) 128 (e.g., liquid crystal displays, light emitting diodes, speakers, etc.) that enable a user of the grill 100 to interact with the above-described control system of the grill 100. In the illustrated example of FIG. 1, the user interface 124 is operatively coupled to (e.g., in electrical communication with) the controller 134 and/or the memory 144 of the grill 100. In some examples, the user interface 124 is mechanically coupled to (e.g., fixedly connected to) the grill 100. For example, the user interface 124 can be mounted to the cookbox 202, the lid 204, the handle 206, the frame 208, the cabinet 210, the control panel 212, the first side table 214, and/or the second side table 216 of the grill 100. The user interface 124 is preferably mounted to a portion of the grill 100 that is readily accessible to a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100. In some examples, respective ones of the input device(s) 126 and/or the output device(s) 128 of the user interface 124 can be mounted to different portions of the grill 100. For example, a first one of the input device(s) 126 can be mounted to a side portion of either the cookbox 202, the lid 204, the handle 206, the frame 208, the cabinet 210, the control panel 212, the first side table 214, or the second side table 216 of the grill 100, and a second one of the input device(s) 126 can be mounted to a front portion of either the cookbox 202, the lid 204, the handle 206, the frame 208, the cabinet 210, the control panel 212, the first side table 214, or the second side table 216 of the grill 100. The architecture and/or operations of the user interface 124 can be distributed among any number of user interfaces respectively having any number of input device(s) 126 and/or output device(s) 128 located at and/or mounted to any portion of the grill 100.

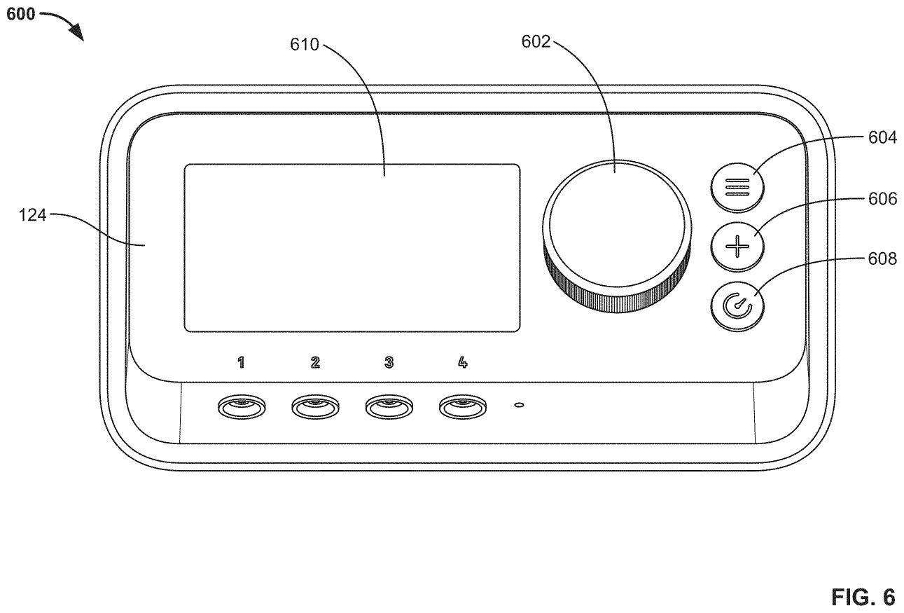

FIG. 6 a front view of an example implementation 600 of the user interface 124 of the grill 100 of FIG. 1. As shown in FIG. 6, the input device(s) 126 of the user interface 124 include an example dial 602, an example first button 604, an example second button 606, and an example third button 608, and the output device(s) 128 of the user interface 124 include an example display 610. In the illustrated example of FIG. 6, the dial 602 of the user interface 124 is a selection dial that can be rotated by a user of the grill 100 to adjust temperatures of the grill 100, and/or to navigate through options presented on the display 610 of the user interface 124. In addition to being rotatable, the dial 602 can also be pushed by a user of the grill 100 to make and/or confirm a selection of one of the options presented on the display 610. The first button 604 of the user interface 124 is a menu button that can be pressed by a user of the grill 100 to access a main menu (e.g., a “home” menu) of selectable options, and to cause the main menu to be presented on the display 610 of the user interface 124. The second button 606 of the user interface 124 is a cook program button that can be pressed by a user of the grill 100 to access a library of selectable cook programs, and to cause steps, instructions, operations, notifications, and/or alerts associated with the selectable cook programs to be presented on the display 610 of the user interface 124. The third button 608 of the user interface 124 is a timer button that can be pressed by a user of the grill 100 to initiate a timer, and to cause the running time associated with the timer to be presented on the display 610 of the user interface 124. The display 610 of the user interface 124 is a liquid crystal display configured to present textual and/or graphical information to a user of the grill 100. In some examples, the display 610 can be implemented as a touch screen, in which case the display 610 serves not only as one of the output device(s) 128 of the user interface 124, but also as another one of the input device(s) 126 of the user interface 124.

In some examples, one or more user input(s), selection(s), instruction(s), command(s) and/or interaction(s) can be received via the dial 602, the first button 604, the second button 606, the third button 608, or the display 610 of the user interface 124 in connection with the selection and/or the implementation of one or more selectable cook programs to be implemented via the control system of the grill 100. For example, one or more user input(s), selection(s), instruction(s), command(s) and/or interaction(s) received via the dial 602, the first button 604, the second button 606, the third button 608, or the display 610 of the user interface 124 may be indicative of a user-based selection of a cook program from among a library of selectable cook programs that are available for implementation via the control system of the grill 100. As another example, one or more user input(s), selection(s), instruction(s), command(s) and/or interaction(s) received via the dial 602, the first button 604, the second button 606, the third button 608, or the display 610 of the user interface 124 may be indicative of a user-based confirmation (or override) input associated with the performance of a lid-opening step, and/or associated with the performance of a cooking operation that requires a lid-opening step, in connection with a selected cook program being implemented via the control system of the grill 100.

In some examples, one or more notification(s) (e.g., one or more visible, audible, and/or tactile message(s) or alert(s)) can be presented via the display 610 of the user interface 124 in connection with the selection and/or the implementation of one or more selectable cook programs to be implemented via the control system of the grill 100. For example, one or more notification(s) (e.g., one or more visible, audible, and/or tactile message(s) or alert(s)) presented via the display 610 of the user interface 124 may inform the user of the grill 100 that a plurality of cook programs are available for selection and/or implementation. As another example, one or more notification(s) presented via the display 610 of the user interface 124 may inform the user of the grill 100 that a particular cook program has been selected for implementation. As another example, one or more notification(s) presented via the display 610 of the user interface 124 may inform the user of the grill 100 that the selected cooking program being implemented via the control system of the grill 100 has advanced to a lid-opening step, and/or to a cooking operation that requires a lid-opening step. As another example, one or more notification(s) presented via the display 610 of the user interface 124 may inform the user of the grill 100 that a lid-opening step, and/or a cooking operation that requires a lid-opening step, is/are due to be performed in connection with the selected cook program being implemented via the control system of the grill 100. As another example, one or more notification(s) presented via the display 610 of the user interface 124 may inform the user of the grill 100 that a lid-opening step, and/or a cooking operation that requires a lid-opening step, has/have been performed in connection with the selected cook program being implemented via the control system of the grill 100.

The network interface 130 of FIG. 1 includes one or more communication device(s) 132 (e.g., transmitter(s), receiver(s), transceiver(s), modem(s), gateway(s), wireless access point(s), etc.) to facilitate exchange of data with external machines (e.g., computing devices of any kind, including the remote device(s) 146 of FIG. 1) by a wired or wireless communication network. Communications transmitted and/or received via the communication device(s) 132 and/or, more generally, via the network interface 130 can be made over and/or carried by, for example, an Ethernet connection, a digital subscriber line (DSL) connection, a telephone line connection, a coaxial cable system, a satellite system, a wireless system, a cellular telephone system, an optical connection, etc. The network interface 130 enables a user of the grill 100 to remotely interact (e.g., via one or more of the remote device(s) 146) with the above-described control system of the grill 100. In the illustrated example of FIG. 1, the network interface 130 is operatively coupled to (e.g., in electrical communication with) the controller 134 and/or the memory 144 of the grill 100.

The remote device(s) 146 of FIG. 1 can be implemented by any type(s) and/or any number(s) of mobile or stationary computing devices. In this regard, examples of such remote device(s) 146 include a smartphone, a tablet, a laptop, a desktop, a cloud server, a wearable computing device, etc. The remote device(s) 146 of FIG. 1 facilitate a remote (e.g., wired, or wireless) extension of the above-described user interface 124 of the grill 100. In this regard, each remote device 146 includes one or more input device(s) and/or one or more output device(s) that mimic and/or enable a remotely-located version of the above-described functionality of the corresponding input device(s) 126 and/or the corresponding output device(s) 128 of the user interface 124 of the grill 100. Accordingly, one or more user input(s), selection(s), instruction(s), command(s) and/or interaction(s) generated via the input device(s) of the remote device(s) 146 can be received at the grill 100 (e.g., via the communication device(s) 132 of the network interface 130 of the grill 100) in connection with the selection and/or the implementation of one or more selectable cook programs to be implemented via the control system of the grill 100. In this same regard, one or more notification(s) (e.g., one or more visible, audible, and/or tactile message(s) or alert(s)) transmitted from the grill 100 (e.g., via the communication device(s) 132 of the network interface 130 of the grill 100) can be presented via the output device(s) of the remote device(s) 146 in connection with the selection and/or the implementation of one or more selectable cook programs to be implemented via the control system of the grill 100

The controller 134 of FIG. 1 manages and/or controls the control system of the grill 100 and/or the components thereof. In the illustrated example of FIG. 1, the controller 134 is operatively coupled to (e.g., in electrical communication with) the fuel source valve 108, the first burner valve 112, the second burner valve 114, the first ignitor 116, the second ignitor 118, the lid position sensor 120, the temperature sensor 122, the user interface 124 (e.g., including the input device(s) 126 and the output device(s) 128), the network interface 130 (e.g., including the communication device(s) 132), and/or the memory 144 of the grill 100 of FIG. 1. The controller 134 of FIG. 1 is also operatively coupled to (e.g., in wired or wireless electrical communication with) the remote device(s) 146 of FIG. 1 via the network interface 130 (e.g., including the communication device(s) 132) of the grill 100 of FIG. 1. In the illustrated example of FIG. 1, the controller 134 includes the valve control circuitry 136, the ignitor control circuitry 138, the cook program control circuitry 140, and the lid position detection circuitry 142 of FIG. 1, each of which is discussed in further detail herein. The valve control circuitry 136, the ignitor control circuitry 138, the cook program control circuitry 140, the lid position detection circuitry 142, and/or, more generally, the controller 134 of FIG. 1 can individually and/or collectively be implemented by any type(s) and/or any number(s) of semiconductor device(s) (e.g., processor(s), microprocessor(s), microcontroller(s), etc.) and/or circuit(s).

In the illustrated example of FIG. 1, the controller 134 is graphically represented as a single, discrete structure that manages and/or controls the operation(s) of various components of the control system of the grill 100. It is to be understood, however, that in other examples, the architecture and/or operations of the controller 134 can be distributed among any number of controllers, with each separate controller having a dedicated subset of one or more operation(s) described herein. As but one example, the controller 134 of FIG. 1 can be separated into four distinct controllers, whereby a first one of the four controllers includes the valve control circuitry 136 of the controller 134, a second one of the four controllers includes the ignitor control circuitry 138 of the controller 134, a third one of the four controllers includes the cook program control circuitry 140 of the controller 134, and a fourth one of the four controllers includes the lid position detection circuitry 142 of the controller 134. In some examples, the grill 100 can further include separate, distinct controllers for one or more of the fuel source valve 108, the first burner valve 112, the second burner valve 114, the first ignitor 116, the second ignitor 118, the lid position sensor 120, the temperature sensor 122, the user interface 124, and/or the network interface 130 of the control system of the grill 100.

The controller 134 of FIG. 1 manages and/or controls the selection and implementation of cook programs for the grill 100 of FIG. 1. In this regard, one or more cook program(s) to be implemented via the controller 134 and/or, more generally, via the control system of the grill 100 can be selected (e.g., by a user of the grill 100) from among a library of selectable cook programs that are available for implementation. In some examples, the controller 134 determines whether a cook program selection has been received at the grill 100. For example, the controller 134 may determine that a cook program selection has been received based on a user input, a user selection, and/or a user interaction (e.g., a press, a push, a pull, a rotation, a click, a flip, a swipe, a touch, etc.) of, to, and/or with one or more of the input device(s) 126 (e.g., a button, a dial, a knob, a switch, a touchscreen, etc.) of the user interface 124 of FIG. 1. As another example, the controller 134 may determine that a cook program selection has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 146 of FIG. 1, as received and/or detected via the network interface 130 of FIG. 1. In response determining that a cook program selection has been received at the grill 100, the controller 134 invokes the valve control circuitry 136, the ignitor control circuitry 138, the cook program control circuitry 140, and/or the lid position detection circuitry 142 of FIG. 1 to implement (e.g., execute) the selected cook program via the control system of the grill 100, as further described herein.

The valve control circuitry 136 of the controller 134 of FIG. 1 manages and/or controls one or more operation(s) of the first burner valve 112 and/or the second burner valve 114 of the grill 100 of FIG. 1. In some examples, the valve control circuitry 136 instructs, commands, signals, and/or otherwise causes the first burner valve 112 and/or the second burner valve 114 to open (e.g., fully open) in connection with an automated startup process that may be incorporated into a cook program to be implemented (e.g., executed) by the control system of the grill 100. In other some examples, the valve control circuitry 136 instructs, commands, signals, and/or otherwise causes the first burner valve 112 and/or the second burner valve 114 to close (e.g., fully close) in connection with an automated shutdown process that may be incorporated into a cook program to be implemented (e.g., executed) by the control system of the grill 100. In still other examples, the valve control circuitry 136 instructs, commands, signals, and/or otherwise causes the first burner valve 112 and/or the second burner valve 114 to maintain a partially-open or fully-open position that facilitates maintaining a setpoint temperature within the cooking chamber 302 of the grill 100 in connection with the implementation (e.g., execution) of a cook program by the control system of the grill 100. In some examples, the valve control circuitry 136 of the controller 134 of FIG. 1 also manages and/or controls one or more operation(s) of the fuel source valve 108 of the grill 100 of FIG. 1. For example, the valve control circuitry 136 of the controller 134 can instruct, command, signal, and/or otherwise cause the fuel source valve 108 to open (e.g., fully open) in connection with an automated startup process that may be incorporated into a cook program to be implemented (e.g., executed) by the control system of the grill 100, or to close (e.g., fully close) in connection with an automated shutdown process that may be incorporated into a cook program to be implemented (e.g., executed) by the control system of the grill 100. In some examples, one or more operation(s) of the valve control circuitry 136 of the controller 134 of FIG. 1 may be under the management and/or control of the cook program control circuitry 140 of the controller 134 of FIG. 1, as further described below.

The ignitor control circuitry 138 of the controller 134 of FIG. 1 manages and/or controls one or more operation(s) of the first ignitor 116 and/or the second ignitor 118 of the grill 100 of FIG. 1. In some examples, the ignitor control circuitry 138 instructs, commands, signals, and/or otherwise causes the first ignitor 116 and/or the second ignitor 118 to ignite corresponding ones of the first burner 102 and/or the second burner 104 of the grill 100 in connection with an automated startup process that may be incorporated into a cook program to be implemented (e.g., executed) by the control system of the grill 100. In some examples, one or more operation(s) of the ignitor control circuitry 138 of the controller 134 of FIG. 1 may be under the management and/or control of the cook program control circuitry 140 of the controller 134 of FIG. 1, as further described below.

The cook program control circuitry 140 of the controller 134 of FIG. 1 instructs, commands, signals, and/or otherwise causes the control system of the grill 100 of FIG. 1 to implement (e.g., execute) a selected cook program (e.g., the ordered steps of a cook program specified by and/or otherwise corresponding to the cook program selection received at the grill 100). In connection with the implementation (e.g., execution) of the selected cook program, the cook program control circuitry 140 manages and/or controls the advancement and/or progression of a series of ordered steps of the cook program, with the ordered steps including a combination of: (1) fully-automated steps that can be performed (e.g., at the direction of the valve control circuitry 136 and/or the ignitor control circuitry 138 of the controller 134 of FIG. 1, under the management or control of the cook program control circuitry 140 of the controller 134) without requiring user interaction with any component(s) of the grill 100; and (2) lid-opening steps that require user interaction to move the lid 204 of the grill 100 relative to the cookbox 202 of the grill 100 from a closed position (e.g., the closed position 200 of FIG. 2) to or toward an open position (e.g., the open position 300 of FIG. 3).

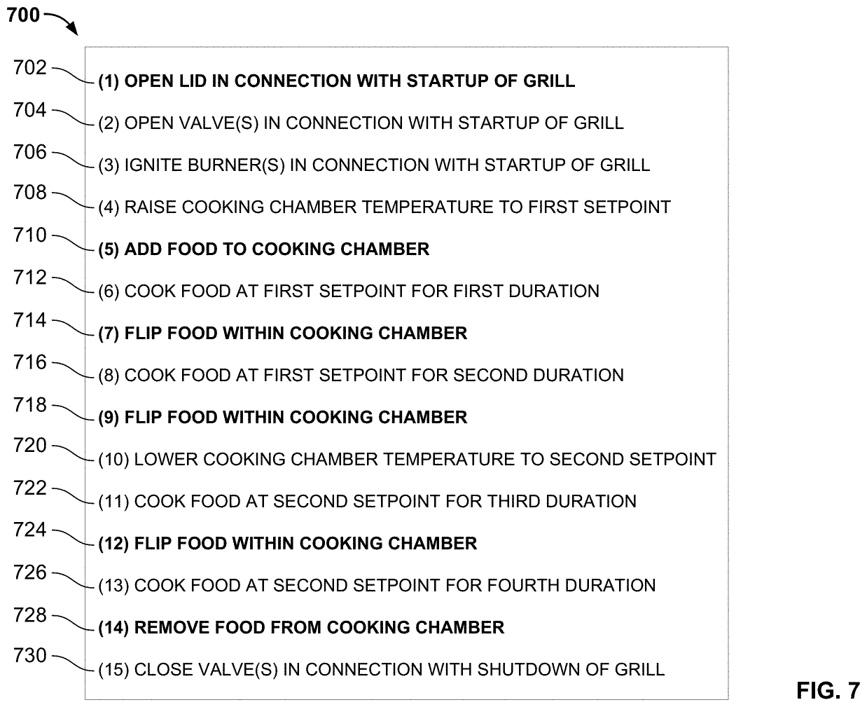

FIG. 7 is a logical representation of an example cook program 700 to be implemented by the control system of the grill 100 of FIG. 1. The cook program 700 of FIG. 7 comprises fifteen ordered steps, instructions, and/or operations including an example first step 702, an example second step 704, an example third step 706, an example fourth step 708, an example fifth step 710, an example sixth step 712, an example seventh step 714, an example eighth step 716, an example ninth step 718, an example tenth step 720, an example eleventh step 722, an example twelfth step 724, an example thirteenth step 726, an example fourteenth step 728, and an example fifteenth step 730. In other examples, the cook program 700 of FIG. 7 can include a different number (e.g., less than fifteen or greater than fifteen) of ordered steps, instructions, and/or operations.

In the illustrated example of FIG. 7, the second step 704, the third step 706, the fourth step 708, the sixth step 712, the eighth step 716, the tenth step 720, the eleventh step 722, the thirteenth step 726, and the fifteenth step 730 of the cook program 700 are fully-automated steps capable of being implemented by the controller 134 and/or, more, generally, by the control system of the grill 100 of FIG. 1 in a fully-automated manner without requiring user interaction with any component(s) of the grill 100. For example, in connection with performing the second step 704 of the cook program 700 of FIG. 7, the valve control circuitry 136 of the controller 134 of FIG. 1 can instruct, command, signal, and/or otherwise cause the first burner valve 112 and/or the second burner valve 114 of FIG. 1 to open. As another example, in connection with performing the third step 706 of the cook program 700 of FIG. 7, the ignitor control circuitry 138 of the controller 134 of FIG. 1 can instruct, command, signal, and/or otherwise cause the first ignitor 116 and/or the second ignitor 118 of FIG. 1 to ignite corresponding ones of the first burner 102 and/or the second burner 104. As another example, in connection with performing the fourth step 708 of the cook program 700 of FIG. 7, the valve control circuitry 136 of the controller 134 of FIG. 1 can instruct, command, signal, and/or otherwise cause the first burner valve 112 and/or the second burner valve 114 of FIG. 1 to one or more positions that facilitate raising the temperature within the cooking chamber 302 of the grill 100 to a first setpoint temperature defined by the cook program 700. As another example, in connection with performing the sixth step 712 of the cook program 700 of FIG. 7, the valve control circuitry 136 of the controller 134 of FIG. 1 can instruct, command, signal, and/or otherwise cause the first burner valve 112 and/or the second burner valve 114 of FIG. 1 to one or more positions that facilitate maintaining the first setpoint temperature within the cooking chamber 302 of the grill 100 for a first duration (e.g., a first period of time) defined by the cook program 700.

By contrast, the first step 702, the fifth step 710, the seventh step 714, the ninth step 718, the twelfth step 724, and the fourteenth step 728 of the cook program 700 are lid-opening steps that cannot be implemented by the control system of the grill 100 in a fully-automated manner. In this regard, each lid-opening step of the cook program 700 requires a user of the grill 100 to move the lid 204 of the grill 100 relative to the cookbox 202 of the grill 100 from a closed position (e.g., the closed position 200 of FIG. 2) to or toward an open position (e.g., the open position 300 of FIG. 3), thereby enabling the user of the grill 100 to access the cooking chamber 302 of the grill 100 for a specific purpose associated with the corresponding lid-opening step. For example, in connection with performing the first step 702 of the cook program 700 of FIG. 7, the user of the grill 100 is required to move the lid 204 of the grill 100 relative to the cookbox 202 of the grill 100 from a closed position to or toward an open position to facilitate a startup process of the grill 100 that involves igniting the first burner 102 and/or the second burner 104 of the grill 100. As another example, in connection with performing the fifth step 710 of the cook program 700 of FIG. 7, the user of the grill 100 is required to move the lid 204 of the grill 100 relative to the cookbox 202 of the grill 100 from a closed position to or toward an open position to facilitate adding one or more item(s) of food to the cooking chamber 302 of the grill 100. As another example, in connection with performing the seventh step 714 of the cook program 700 of FIG. 7, the user of the grill 100 is required to move the lid 204 of the grill 100 relative to the cookbox 202 of the grill 100 from a closed position to or toward an open position to facilitate flipping one or more item(s) of food within the cooking chamber 302 of the grill 100. As another example, in connection with performing the fourteenth step 728 of the cook program 700 of FIG. 7, the user of the grill 100 is required to move the lid 204 of the grill 100 relative to the cookbox 202 of the grill 100 from a closed position to or toward an open position to facilitate removing one or more item(s) of food from the cooking chamber 302 of the grill 100. In still other examples, the cook program 700 of FIG. 7 can include one or more additional or alternative lid-opening step(s) that require the user of the grill 100 to move the lid 204 of the grill 100 relative to the cookbox 202 of the grill 100 from a closed position to or toward an open position to facilitate rotating, relocating, and/or otherwise moving one or more item(s) of food within the cooking chamber 302 of the grill 100.

When implementing (e.g., executing) a selected cook program, the cook program control circuitry 140 of FIG. 1 determines whether the ordered steps of the cook program have advanced to a lid-opening step (e.g., a step that requires the user of the grill 100 to move the lid 204 of the grill 100 relative to the cookbox 202 of the grill 100 from a closed position to or toward an open position). For example, the cook program control circuitry 140 may determine that the ordered steps of the cook program have advanced to one of the lid-opening steps represented by the first step 702, the fifth step 710, the seventh step 714, the ninth step 718, the twelfth step 724, or the fourteenth step 728 of the cook program 700 of FIG. 7. In instances where the cook program control circuitry 140 determines that the ordered steps of the cook program have not yet advanced to a lid-opening step, the cook program control circuitry 140 continues with the implementation (e.g., execution) of one or more fully-automated step(s) from among the ordered steps of the cook program, and does so until the ordered steps of the cook program have advanced to a lid-opening step. Conversely, in instances where the cook program control circuitry 140 determines that the ordered steps of the cook program have advanced to a lid-opening step, the cook program control circuitry 140 generates a notification (e.g., a visible, audible, and/or tactile message or alert) associated with the current lid-opening step (e.g., the lid-opening step to which the cook program has currently advanced). For example, in response to the cook program control circuitry 140 determining that the ordered steps of the cook program have advanced to one of the lid-opening steps represented by the first step 702, the fifth step 710, the seventh step 714, the ninth step 718, the twelfth step 724, or the fourteenth step 728 of the cook program 700 of FIG. 7, the cook program control circuitry 140 generates a notification associated with the corresponding one of the lid-opening steps represented by the first step 702, the fifth step 710, the seventh step 714, the ninth step 718, the twelfth step 724, or the fourteenth step 728 of the cook program 700 of FIG. 7.

In some examples, the cook program control circuitry 140 generates a notification that is intended to directly inform a user of the grill 100 that the lid 204 of the grill 100 needs to be moved from a closed position (e.g., the closed position 200 of FIG. 2) to or toward an open position (e.g., the open position 300 of FIG. 3). For example, the cook program control circuitry 140 may generate a notification expressly instructing the user of the grill 100 to open the lid 204 of the grill 100. In other examples, the cook program control circuitry 140 generates a notification that is intended to inherently inform a user of the grill 100 that the lid 204 of the grill 100 needs to be moved from a closed position (e.g., the closed position 200 of FIG. 2) to or toward an open position (e.g., the open position 300 of FIG. 3). For example, the cook program control circuitry 140 may generate a notification instructing the user of the grill 100 to add an item of food to the cooking chamber 302 of the grill 100, to remove an item of food from the cooking chamber 302 of the grill 100, or to flip, rotate, relocate, or otherwise move an item of food within the cooking chamber 302 of the grill 100, all of which inherently require the user to open the lid 204 of the grill 100 such that the user can access the cooking chamber 302 of the grill 100.

The cook program control circuitry 140 of FIG. 1 thereafter instructs, commands, signals, and/or otherwise causes the notification associated with the current lid-opening step to be presented locally (e.g., at the grill 100) and/or remotely (e.g., at a location separate from the grill 100). For example, the cook program control circuitry 140 may instruct, command, signal, and/or otherwise cause the user interface 124 of the grill 100 of FIG. 1 to locally present (e.g., via one or more of the output device(s) 128 of the user interface 124) the notification associated with the current lid-opening step. As another example, the cook program control circuitry 140 may additionally or alternatively instruct, command, signal, and/or otherwise cause the network interface 130 of the grill 100 of FIG. 1 to transmit (e.g., via one or more of the communication device(s) 132 of the network interface 130) the notification associated with the current lid-opening step to one or more of the remote device(s) 146 of FIG. 1 for remote presentation via one or more of the output device(s) of the remote device(s) 146.

Subsequent to the local and/or remote presentation(s) of the notification associated with the current lid-opening step, and as a further response to determining that the ordered steps of the cook program have advanced to a lid-opening step, the cook program control circuitry 140 invokes the lid position detection circuitry 142 of FIG. 1 to assist the cook program control circuitry 140 in determining when to advance the ordered steps of cook program from the current lid-opening step to a next step (e.g., a fully-automated step) of the cook program. The lid position detection circuitry 142 of the controller 134 of FIG. 1 determines and/or detects whether a lid-opening step of a cook program has been performed based on lid position data evaluated by the lid position detection circuitry 142. For example, the lid position detection circuitry 142 may determine that a lid-opening step of a cook program has been performed when the lid position data evaluated by the lid position detection circuitry 142 indicates that the lid 204 of the grill 100 has moved relative to the cookbox 202 of the grill 100 from a closed position (e.g., the closed position 200 of FIG. 2) to or toward an open position (e.g., the open position 300 of FIG. 3). In some examples, the lid position data evaluated by the lid position detection circuitry 142 is sensed, measured, and/or detected via the lid position sensor 120 of the grill 100 of FIG. 1. For example, the lid position detection circuitry 142 may determine that a lid-opening step of a cook program has been performed when lid position data sensed, measured, and/or detected by the lid position sensor 120 indicates that the lid 204 of the grill 100 is in an open position, and/or that the lid 204 of the grill 100 has moved away from a closed position and toward an open position. In other examples, the lid position data evaluated by the lid position detection circuitry 142 is derived from temperature data that is sensed, measured, and/or detected via the temperature sensor 122 of the grill 100 of FIG. 1. For example, the lid position detection circuitry 142 may determine that a lid-opening step of a cook program has been performed when temperature data sensed, measured, and/or detected by the temperature sensor 122 indicates a threshold decrease (e.g., a rapid decline) in the temperature within the cooking chamber 302 of the grill 100. In such an example, the lid position detection circuitry 142 derives lid position data from the temperature data by identifying the threshold decrease in the temperature within the cooking chamber 302 as corresponding to the lid 204 of the grill 100 being moved from a closed position to or toward an open position.

In response to the lid position detection circuitry 142 of FIG. 1 determining and/or detecting, based on the evaluated lid position data, that the current lid-opening step of the cook program has been performed, the cook program control circuitry 140 of FIG. 1 automatically advances the ordered steps of the cook program from the current lid-opening step to a next step (e.g., a fully-automated step) of the cook program. For example, the cook program control circuitry 140 may automatically advance the ordered steps of the cook program from the lid-opening step represented by the first step 702 of the cook program 700 of FIG. 7 to the fully-automated step represented by the second step 704 of the cook program 700 of FIG. 7. As another example, the cook program control circuitry 140 may automatically advance the ordered steps of the cook program from the lid-opening step represented by the fifth step 710 of the cook program 700 of FIG. 7 to the fully-automated step represented by the sixth step 712 of the cook program 700 of FIG. 7. As yet another example, the cook program control circuitry 140 may automatically advance the ordered steps of the cook program from the lid-opening step represented by the seventh step 714 of the cook program 700 of FIG. 7 to the fully-automated step represented by the eighth step 716 of the cook program 700 of FIG. 7. As yet another example, the cook program control circuitry 140 may automatically advance the ordered steps of the cook program from the lid-opening step represented by the fourteenth step 728 of the cook program 700 of FIG. 7 to the fully-automated step represented by the fifteenth step 730 of the cook program 700 of FIG. 7. As a substantial advantage relative to known cook program implementations, the cook program control circuitry 140 of FIG. 1 automatically advances the ordered steps of the cook program from the current lid-opening step to a next step (e.g., a fully-automated step) of the cook program based solely on the detected lid position data, without the control system of the grill 100 separately receiving a user input instructing the controller 134 and/or, more generally, the control system of the grill 100 to advance the ordered steps of the cook program from the lid-opening step to the next step, and/or without the control system of the grill 100 separately receiving a user input indicating that the lid-opening step has been performed.

The above-described operations of the cook program control circuitry 140 and the lid position detection circuitry 142 of FIG. 1 continue in an iterative and/or repeated manner until the cook program control circuitry 140 determines that all of the lid-opening steps (e.g., each of the first step 702, the fifth step 710, the seventh step 714, the ninth step 718, the twelfth step 724, and the fourteenth step 728 of the cook program 700 of FIG. 7) from among the ordered steps of the selected cook program have been performed. Upon determining that all of the lid-opening steps from among the ordered steps of the selected cook program have been performed, the cook program control circuitry 140 continues the implementation (e.g., execution) of any remaining fully-automated steps (e.g., the fifteenth step 730 of the cook program 700 of FIG. 7) from among the ordered steps of the selected cook program, and does so until the cook program control circuitry 140 determines that all of the steps (including both the lid-opening steps and the fully-automated steps) from among the ordered steps of the cook program have been performed.

The memory 144 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 144 of FIG. 1 can be stored in any file and/or data structure format, organization scheme, and/or arrangement.

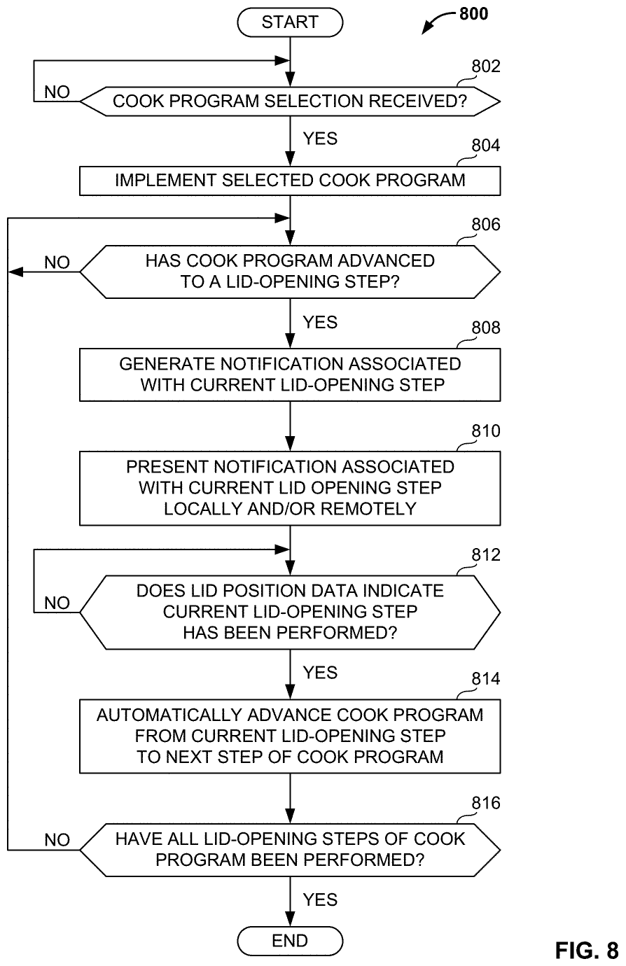

The memory 144 stores data sensed, measured, detected, generated, input, output, transmitted, and/or received by, to, and/or from the fuel source valve 108, the first burner valve 112, the second burner valve 114, the first ignitor 116, the second ignitor 118, the lid position sensor 120, the temperature sensor 122, the user interface 124 (e.g., including the input device(s) 126 and the output device(s) 128), the network interface 130 (e.g., including the communication device(s) 132), the controller 134 (e.g., including the valve control circuitry 136, the ignitor control circuitry 138, the cook program control circuitry 140, and the lid position detection circuitry 142), the remote device(s) 146, and/or, more generally, the control system of the grill 100 of FIG. 1. The memory 144 also stores instructions (e.g., machine-readable instructions) and associated data corresponding to the cook programs to be implemented via the control system of the grill 100 of FIG. 1, and/or corresponding to the processes, protocols, sequences, and/or methods described below in connection with FIG. 8. The memory 144 of FIG. 1 is accessible to one or more of the fuel source valve 108, the first burner valve 112, the second burner valve 114, the first ignitor 116, the second ignitor 118, the lid position sensor 120, the temperature sensor 122, the user interface 124 (e.g., including the input device(s) 126 and the output device(s) 128), the network interface 130 (e.g., including the communication device(s) 132), the controller 134 (e.g., including the valve control circuitry 136, the ignitor control circuitry 138, the cook program control circuitry 140, and the lid position detection circuitry 142), the remote device(s) 146, and/or, more generally, the control system of the grill 100 of FIG. 1.

While an example manner of implementing the control system of the grill 100 is illustrated in FIG. 1, one or more of the elements, processes, and/or devices illustrated in FIG. 1 may be combined, divided, re-arranged, omitted, eliminated, and/or implemented in any other way. Further, the example fuel source valve 108, the example first burner valve 112, the example second burner valve 114, the example first ignitor 116, the example second ignitor 118, the example lid position sensor 120, the example temperature sensor 122, the example user interface 124 (e.g., including the example input device(s) 126 and the example output device(s) 128), the example network interface 130 (e.g., including the example communication device(s) 132), the example controller 134 (e.g., including the example valve control circuitry 136, the example ignitor control circuitry 138, the example cook program control circuitry 140, and the example lid position detection circuitry 142), the example memory 144, and/or, more generally, the control system of the grill 100 of FIG. 1, may be implemented by hardware, software, firmware, and/or any combination of hardware, software, and/or firmware. Thus, for example, any of the example fuel source valve 108, the example first burner valve 112, the example second burner valve 114, the example first ignitor 116, the example second ignitor 118, the example lid position sensor 120, the example temperature sensor 122, the example user interface 124 (e.g., including the example input device(s) 126 and the example output device(s) 128), the example network interface 130 (e.g., including the example communication device(s) 132), the example controller 134 (e.g., including the example valve control circuitry 136, the example ignitor control circuitry 138, the example cook program control circuitry 140, and the example lid position detection circuitry 142), the example memory 144, and/or, more generally, the control system of the grill 100 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example fuel source valve 108, the example first burner valve 112, the example second burner valve 114, the example first ignitor 116, the example second ignitor 118, the example lid position sensor 120, the example temperature sensor 122, the example user interface 124 (e.g., including the example input device(s) 126 and the example output device(s) 128), the example network interface 130 (e.g., including the example communication device(s) 132), the example controller 134 (e.g., including the example valve control circuitry 136, the example ignitor control circuitry 138, the example cook program control circuitry 140, and the example lid position detection circuitry 142), and/or the example memory 144 is/are hereby expressly defined to include a non-transitory computer readable storage device or storage disk such as a memory, a digital versatile disk (DVD), a compact disk (CD), a Blu-ray disk, etc., including the software and/or firmware. Further still, the example control system of the grill of FIG. 1 may include one or more elements, processes, and/or devices in addition to, or instead of, those illustrated in FIG. 1, and/or may include more than one of any or all of the illustrated elements, processes, and devices.

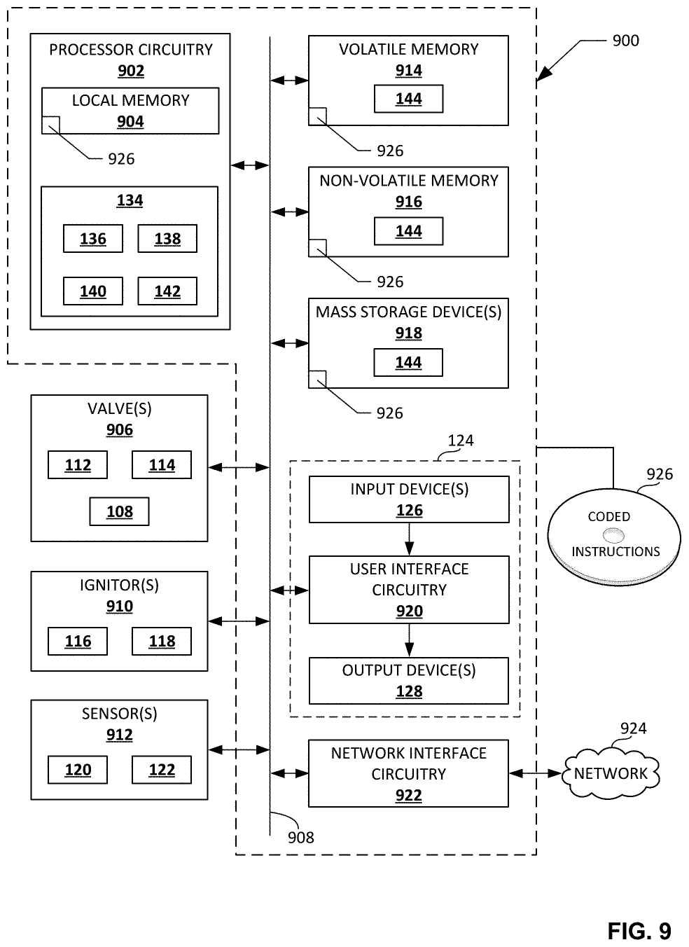

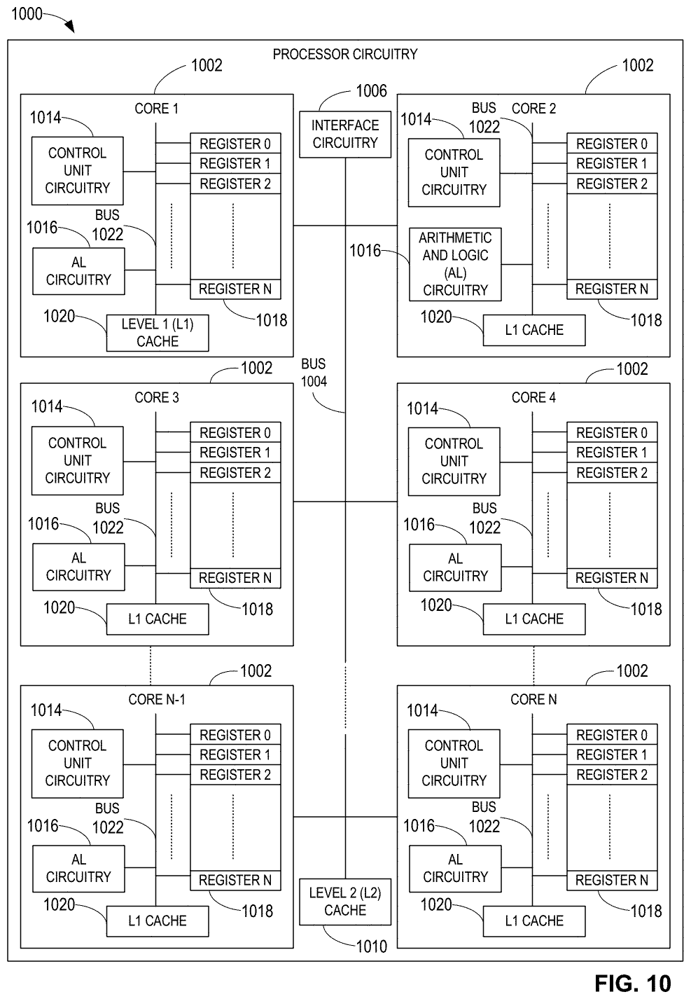

A flowchart representative of example hardware logic circuitry, machine-readable instructions, hardware implemented state machines, and/or any combination thereof for implementing the grill 100 of FIG. 1 is shown in FIG. 8. The machine-readable instructions may be one or more executable programs or portion(s) of an executable program for execution by processor circuitry, such as the processor circuitry 902 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although an example program is described with reference to the flowchart illustrated in FIG. 8, many other methods of implementing the example grill 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable medium” and “non-transitory computer-readable storage medium” are expressly defined to include any type of computer-readable storage device and/or storage disk and to exclude propagating signals and to exclude transmission media.

The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine-readable instructions and/or example operations 800 that may be executed by processor circuitry to implement the grill 100 of FIG. 1. The machine-readable instructions and/or operations 800 of FIG. 8 begin at block 802 when the controller 134 of FIG. 1 determines whether a cook program selection has been received. For example, the controller 134 may determine that a cook program selection has been received based on a user input, a user selection, and/or a user interaction (e.g., a press, a push, a pull, a rotation, a click, a flip, a swipe, a touch, etc.) of, to, and/or with one or more of the input device(s) 126 (e.g., a button, a dial, a knob, a switch, a touchscreen, etc.) of the user interface 124 of FIG. 1. As another example, the controller 134 may determine that a cook program selection has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 146 of FIG. 1, as received and/or detected via the network interface 130 of FIG. 1. If the controller 134 determines at block 802 that a cook program selection has not been received, control of the machine-readable instructions and/or operations 800 of FIG. 8 remains at block 802. If the controller 134 instead determines at block 802 that a cook program selection has been received, control of the machine-readable instructions and/or operations 800 of FIG. 8 proceeds to block 804.

At block 804, the cook program control circuitry 140 of the controller 134 of FIG. 1 instructs, commands, signals, and/or otherwise causes the control system of the grill 100 of FIG. 1 to implement (e.g., to execute) the selected cook program (e.g., a cook program specified by and/or otherwise corresponding to the cook program selection received at block 802). For example, the cook program control circuitry 140 may instruct, command, signal, and/or otherwise cause the control system of the grill 100 of FIG. 1 to implement the ordered steps of the cook program 700 of FIG. 7. In connection with the implementation (e.g., the execution) of the selected cook program, the cook program control circuitry 140 manages and/or controls the advancement and/or progression of the ordered steps of the cook program, with the ordered steps including a combination of: (1) fully-automated steps that can be performed (e.g., at the direction of the valve control circuitry 136 and/or the ignitor control circuitry 138 of the controller 134 of FIG. 1, under the management or control of the cook program control circuitry 140 of the controller 134) without requiring user interaction with any component(s) of the grill 100; and (2) lid-opening steps that require user interaction to move the lid 204 of the grill 100 relative to the cookbox 202 of the grill 100 from a closed position (e.g., the closed position 200 of FIG. 2) to or toward an open position (e.g., the open position 300 of FIG. 3). Following block 804, control of the example machine-readable instructions and/or operations 800 of FIG. 8 proceeds to block 806.

At block 806, the cook program control circuitry 140 of the controller 134 of FIG. 1 determines whether the cook program has advanced to a lid-opening step (e.g., a step that requires the user of the grill 100 to move the lid 204 of the grill 100 relative to the cookbox 202 of the grill 100 from a closed position to or toward an open position). For example, the cook program control circuitry 140 may determine that the cook program has advanced to one of the lid-opening steps represented by the first step 702, the fifth step 710, the seventh step 714, the ninth step 718, the twelfth step 724, or the fourteenth step 728 of the cook program 700 of FIG. 7. If the cook program control circuitry 140 determines at block 806 that the cook program has not advanced to a lid-opening step, control of the machine-readable instructions and/or operations 800 of FIG. 8 remains at block 806, where the implementation (e.g., the execution) of the ordered steps of the cook program continues until the cook program has advanced to a lid-opening step. If the cook program control circuitry 140 instead determines at block 806 that the cook program has advanced to a lid-opening step, control of the machine-readable instructions and/or operations 800 of FIG. 8 proceeds to block 808.

At block 808, the cook program control circuitry 140 of the controller 134 of FIG. 1 generates a notification (e.g., a visible, audible, and/or tactile message or alert) associated with the current lid-opening step (e.g., the lid-opening step to which the cook program has currently advanced). In some examples, the cook program control circuitry 140 generates a notification that is intended to directly inform a user of the grill 100 that the lid 204 of the grill 100 needs to be moved from a closed position (e.g., the closed position 200 of FIG. 2) to or toward an open position (e.g., the open position 300 of FIG. 3). For example, the cook program control circuitry 140 may generate a notification expressly instructing the user of the grill 100 to open the lid 204 of the grill 100. In other examples, the cook program control circuitry 140 generates a notification that is intended to inherently inform a user of the grill 100 that the lid 204 of the grill 100 needs to be moved from a closed position (e.g., the closed position 200 of FIG. 2) to or toward an open position (e.g., the open position 300 of FIG. 3). For example, the cook program control circuitry 140 may generate a notification instructing the user of the grill 100 to add an item of food to the cooking chamber 302 of the grill 100, to remove an item of food from the cooking chamber 302 of the grill 100, or to flip, rotate, relocate, or otherwise move an item of food within the cooking chamber 302 of the grill 100, all of which inherently require the user to open the lid 204 of the grill 100 such that the user can access the cooking chamber 302 of the grill 100. Following block 808, control of the example machine-readable instructions and/or operations 800 of FIG. 8 proceeds to block 810.

At block 810, the cook program control circuitry 140 of the controller 134 of FIG. 1 instructs, commands, signals, and/or otherwise causes the notification associated with the current lid-opening step to be presented locally and/or remotely. For example, the cook program control circuitry 140 may instruct, command, signal, and/or otherwise cause the user interface 124 of the grill 100 of FIG. 1 to locally present (e.g., via one or more of the output device(s) 128 of the user interface 124) the notification associated with the current lid-opening step. As another example, the cook program control circuitry 140 may additionally or alternatively instruct, command, signal, and/or otherwise cause the network interface 130 of the grill 100 of FIG. 1 to transmit (e.g., via one or more of the communication device(s) 132 of the network interface 130) the notification associated with the current lid-opening step to one or more of the remote device(s) 146 of FIG. 1 for remote presentation via one or more of the output device(s) of the remote device(s) 146. Following block 810, control of the example machine-readable instructions and/or operations 800 of FIG. 8 proceeds to block 812.

At block 812, the lid position detection circuitry 142 of the controller 134 of FIG. 1 determines whether lid position data indicates that the current lid-opening step of the cook program has been performed. For example, the lid position detection circuitry 142 may determine that the current lid-opening step of the cook program has been performed when the lid position data indicates that the lid 204 of the grill 100 has moved relative to the cookbox 202 of the grill 100 from a closed position (e.g., the closed position 200 of FIG. 2) to or toward an open position (e.g., the open position 300 of FIG. 3). In some examples, the lid position data evaluated by the lid position detection circuitry 142 at block 812 is sensed, measured, and/or detected via the lid position sensor 120 of the grill 100. For example, the lid position detection circuitry 142 may determine that the current lid-opening step of the cook program has been performed when lid position data sensed, measured, and/or detected by the lid position sensor 120 indicates that the lid 204 of the grill 100 is in an open position, and/or that the lid 204 of the grill 100 has moved away from a closed position and toward an open position. In other examples, the lid position data evaluated by the lid position detection circuitry 142 at block 812 is derived from temperature data that is sensed, measured, and/or detected via the temperature sensor 122 of the grill 100. For example, the lid position detection circuitry 142 may determine that the current lid-opening step of the cook program has been performed when temperature data sensed, measured, and/or detected by the temperature sensor 122 indicates a threshold decrease (e.g., a rapid decline) in the temperature within the cooking chamber 302 of the grill 100. In such an example, the lid position detection circuitry 142 derives lid position data from the temperature data by identifying the threshold decrease in the temperature within the cooking chamber 302 as corresponding to the lid 204 of the grill 100 being moved from a closed position to or toward an open position. If the lid position detection circuitry 142 determines at block 812 that the lid position data does not indicate that the current lid-opening step of the cook program has been performed, control of the machine-readable instructions and/or operations 800 of FIG. 8 remains at block 812. If the lid position detection circuitry 142 determines at block 812 that the lid position data indicates that the current lid-opening step of the cook program has been performed, control of the machine-readable instructions and/or operations 800 of FIG. 8 proceeds to block 814.

At block 814, the cook program control circuitry 140 of the controller 134 of FIG. 1 automatically advances the cook program from the current lid-opening step to a next step (e.g., a fully-automated step) of the cook program. For example, the cook program control circuitry 140 may automatically advance the lid-opening step represented by the first step 702 of the cook program 700 of FIG. 7 to the fully-automated step represented by the second step 704 of the cook program 700 of FIG. 7. As another example, the cook program control circuitry 140 may automatically advance the lid-opening step represented by the fifth step 710 of the cook program 700 of FIG. 7 to the fully-automated step represented by the sixth step 712 of the cook program 700 of FIG. 7. As yet another example, the cook program control circuitry 140 may automatically advance the lid-opening step represented by the seventh step 714 of the cook program 700 of FIG. 7 to the fully-automated step represented by the eighth step 716 of the cook program 700 of FIG. 7. As yet another example, the cook program control circuitry 140 may automatically advance the lid-opening step represented by the fourteenth step 728 of the cook program 700 of FIG. 7 to the fully-automated step represented by the fifteenth step 730 of the cook program 700 of FIG. 7. Following block 814, control of the example machine-readable instructions and/or operations 800 of FIG. 8 proceeds to block 816.

At block 816, the cook program control circuitry 140 of the controller 134 of FIG. 1 determines whether all of the lid-opening steps of the cook program have been performed. For example, if the current lid-opening step of the cook program that is determined to have been performed at block 812 is one of the lid-opening steps represented by the first step 702, the fifth step 710, the seventh step 714, the ninth step 718, or the twelfth step 724 of the cook program 700 of FIG. 7, the cook program control circuitry 140 determines that one or more lid-opening step(s) of the cook program (e.g., at least the lid-opening step represented by the fourteenth step 728 of the cook program 700 of FIG. 7) has/have not yet been performed. Conversely, if the current lid-opening step of the cook program that is determined to have been performed at block 812 is the lid-opening step represented by the fourteenth step 728 of the cook program 700 of FIG. 7, the cook program control circuitry 140 instead determines that all of the lid-opening steps of the cook program have been performed. If the cook program control circuitry 140 determines at block 816 that less than all of the lid-opening steps of the cook program have been performed, control of the machine-readable instructions and/or operations 800 of FIG. 8 returns to block 806, where the implementation (e.g., the execution) of the ordered steps of the cook program continues until the cook program has advanced to the next lid-opening step. If the cook program control circuitry 140 instead determines at block 816 that all of the lid opening steps of the cook program have been performed, the machine-readable instructions and/or operations 800 of FIG. 8 end.

FIG. 9 is a block diagram of an example processor platform 900 including processor circuitry structured to execute and/or instantiate the machine-readable instructions and/or operations 800 of FIG. 8 to implement the grill 100 of FIG. 1. The processor platform 900 of the illustrated example includes processor circuitry 902. The processor circuitry 902 of the illustrated example is hardware. For example, the processor circuitry 902 can be implemented by one or more integrated circuit(s), logic circuit(s), FPGA(s), microprocessor(s), CPU(s), GPU(s), DSP(s), and/or microcontroller(s) from any desired family or manufacturer. The processor circuitry 902 may be implemented by one or more semiconductor based (e.g., silicon based) device(s). In this example, the processor circuitry 902 implements the controller 134 of FIG. 1, including the valve control circuitry 136, the ignitor control circuitry 138, the cook program control circuitry 140, and the lid position detection circuitry 142 of the controller 134.

The processor circuitry 902 of the illustrated example includes a local memory 904 (e.g., a cache, registers, etc.). The processor circuitry 902 is in electrical communication with one or more valve(s) 906 via a bus 908. In this example, the valve(s) 906 include the fuel source valve 108, the first burner valve 112, and the second burner valve 114 of FIG. 1. The processor circuitry 902 is also in electrical communication with one or more ignitor(s) 910 via the bus 908. In this example, the ignitor(s) 910 include the first ignitor 116 and the second ignitor 118 of FIG. 1. The processor circuitry 902 is also in electrical communication with one or more sensor(s) 912 via the bus 908. In this example, the sensor(s) 912 include the lid position sensor 120 and the temperature sensor 122 of FIG. 1.

The processor circuitry 902 is also in electrical communication with a main memory via the bus 908, with the main memory including a volatile memory 914 and a non-volatile memory 916. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller.

The processor platform 900 of the illustrated example also includes one or more mass storage device(s) 918 to store software and/or data. Examples of such mass storage device(s) 918 include magnetic storage devices, optical storage devices, floppy disk drives, HDDs, CDs, Blu-ray disk drives, redundant array of independent disks (RAID) systems, solid state storage devices such as flash memory devices, and DVD drives. In the illustrated example of FIG. 9, one or more of the volatile memory 914, the non-volatile memory 916, and/or the mass storage device(s) 918 implement(s) the memory 144 of FIG. 1.

The processor platform 900 of the illustrated example also includes user interface circuitry 920. The user interface circuitry 920 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 126 are connected to the user interface circuitry 920. The input device(s) 126 permit(s) a user to enter data and/or commands into the processor circuitry 902. The input device(s) 126 can be implemented by, for example, one or more button(s), dial(s), knob(s), switch(es), touchscreen(s), audio sensor(s), microphone(s), image sensor(s), and/or camera(s). One or more output device(s) 128 are also connected to the user interface circuitry 920 of the illustrated example. The output device(s) 128 can be implemented, for example, by one or more display device(s) (e.g., light emitting diode(s) (LED(s)), organic light emitting diode(s) (OLED(s)), liquid crystal display(s) (LCD(s)), cathode ray tube (CRT) display(s), in-place switching (IPS) display(s), touchscreen(s), etc.), tactile output device(s), and/or speaker(s). The user interface circuitry 920 of the illustrated example, thus, typically includes a graphics driver card, a graphics driver chip, and/or graphics processor circuitry such as a GPU. In the illustrated example of FIG. 9, the user interface circuitry 920, the input device(s) 126, and the output device(s) 128 collectively implement the user interface 124 of FIG. 1.

The processor platform 900 of the illustrated example also includes network interface circuitry 922. The network interface circuitry 922 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 146 of FIG. 1) by a network 924. The communication can be by, for example, an Ethernet connection, a digital subscriber line (DSL) connection, a telephone line connection, a coaxial cable system, a satellite system, a wireless system, a cellular telephone system, an optical connection, etc. In the illustrated example of FIG. 9, the network interface circuitry 922 implements the network interface 130 (e.g., including the communication device(s) 132) of FIG. 1.

Coded instructions 926 including the above-described machine-readable instructions and/or operations 800 of FIG. 8 may be stored the local memory 904, in the volatile memory 914, in the non-volatile memory 916, on the mass storage device(s) 918, and/or on a removable non-transitory computer-readable storage medium such as a flash memory stick, a dongle, a CD, or a DVD.

FIG. 10 is a block diagram of an example implementation of the processor circuitry 902 of FIG. 9. In this example, the processor circuitry 902 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations 800 represented by the flowchart of FIG. 8.

The cores 1002 may communicate by an example bus 1004. In some examples, the bus 1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally, or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1022 may implement at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

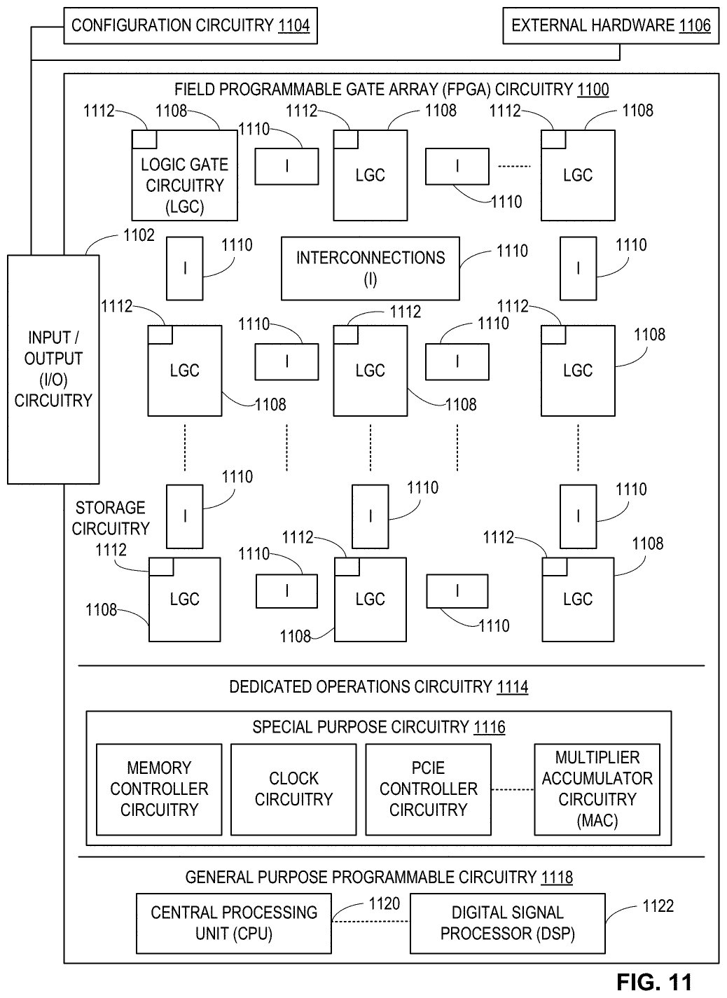

FIG. 11 is a block diagram of another example implementation of the processor circuitry 902 of FIG. 9. In this example, the processor circuitry 902 is implemented by FPGA circuitry 1100. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the machine-readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine-readable instructions and/or operations 800 represented by the flowchart of FIG. 8, but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine-readable instructions and/or operations 800 represented by the flowchart of FIG. 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIG. 8. As such, the FPGA circuitry 1100 may be structured to effectively instantiate some or all of the machine-readable instructions 800 of the flowchart of FIG. 8 as dedicated logic circuits to perform the operations corresponding to those software instructions in a dedicated manner analogous to an ASIC. Therefore, the FPGA circuitry 1100 may perform the operations corresponding to the some or all of the machine-readable instructions 800 of FIG. 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11 includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine-readable instructions to configure the FPGA circuitry 1100, or portion(s) thereof. In some such examples, the configuration circuitry 1104 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine-readable instructions 800 of FIG. 8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 902 of FIG. 9, many other approaches are contemplated. For example, as mentioned above, modern FPGA circuitry may include an on-board CPU, such as one or more of the example CPU 1120 of FIG. 11. Therefore, the processor circuitry 902 of FIG. 9 may additionally be implemented by combining the example microprocessor 1000 of FIG. 10 and the example FPGA circuitry 1100 of FIG. 11. In some such hybrid examples, a first portion of the machine-readable instructions and/or operations 800 represented by the flowchart of FIG. 8 may be executed by one or more of the cores 1002 of FIG. 10 and a second portion of the machine-readable instructions and/or operations 800 represented by the flowchart of FIG. 8 may be executed by the FPGA circuitry 1100 of FIG. 11.

In some examples, the processor circuitry 902 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 902 of FIG. 9, which may be in one or more packages. For example, the XPU may include a CPU in one package, a DSP in another package, a GPU in yet another package, and an FPGA in still yet another package.

From the foregoing, it will be appreciated that the above-disclosed methods and apparatus advantageously automatically advance a cook program from a lid-opening step to a next step (e.g., a fully-automated step) based on detected lid position data indicating that a lid of a grill implementing the cook program has moved from a closed position to or toward an open position. In some examples, the lid position data is sensed, measured, and/or detected via a lid position sensor of the grill. In other examples, the lid position data is derived from temperature data that is sensed, measured, and/or detected via a temperature sensor of the grill. Implementation of the disclosed methods and apparatus for automatically advancing a cook program from a lid-opening step to a next step (e.g., a fully-automated step) advantageously makes the cook program less cumbersome in terms of the extent of user involvement required by the cook program, thereby reducing instances of user error associated with the submission of confirmation inputs that are required of known cook program implementations. The disclosed methods and apparatus accordingly improve the overall quality of the cooking experience associated with preparing an item of food utilizing a cook program, and also provide a user experience that is improved relative to that provided by known cook program implementations.

In some examples, a grill is disclosed. In some disclosed examples, the grill comprises a cookbox, a lid, a cooking chamber, and a controller. In some disclosed examples, the lid is movable relative to the cookbox between a closed position and an open position. In some disclosed examples, the cooking chamber is defined by the cookbox and the lid. In some disclosed examples, the cooking chamber is accessible to a user of the grill when the lid is in the open position. In some disclosed examples, the controller is to implement a cook program to cook an item of food within the cooking chamber. In some disclosed examples, the cook program includes a plurality of ordered steps, with the plurality of ordered steps including a lid-opening step requiring the lid to be moved from the closed position to the open position. In some disclosed examples, the controller is to determine, based on lid position data, whether the lid-opening step has been performed. In some disclosed examples, the controller, in response to determining that the lid-opening step has been performed, is to automatically advance the plurality of ordered steps from the lid-opening step to a next step of the plurality of ordered steps.

In some disclosed examples, the controller is to automatically advance the plurality of ordered steps from the lid-opening step to the next step based on the lid position data and without the grill separately receiving a user input instructing the controller to advance the plurality of ordered steps from the lid-opening step to the next step.

In some disclosed examples, the controller is to automatically advance the plurality of ordered steps from the lid-opening step to the next step based on the lid position data and without the grill separately receiving a user input indicating that the lid-opening step has been performed.

In some disclosed examples, the grill further comprises a lid position sensor in electrical communication with the controller. In some disclosed examples, the lid position data is detected via the lid position sensor.

In some disclosed examples, the lid position sensor is a contact sensor.

In some disclosed examples, the lid position sensor is a proximity sensor.

In some disclosed examples, the lid position sensor is an accelerometer.

In some disclosed examples, the grill further comprises a temperature sensor in electrical communication with the controller. In some disclosed examples, the temperature sensor is to detect temperature data indicating a temperature within the cooking chamber. In some disclosed examples, the controller is to derive the lid position data from the temperature data.

In some disclosed examples, the lid-opening step requires the lid to be moved from the closed position to the open position in association with adding the item of food to the cooking chamber or removing the item of food from the cooking chamber.

In some disclosed examples, the lid-opening step requires the lid to be moved from the closed position to the open position in association with flipping, rotating, or relocating the item of food within the cooking chamber.

In some disclosed examples, the lid-opening step requires the lid to be moved from the closed position to the open position in association with a startup process that involves igniting one or more burners of the grill.

In some examples, a method is disclosed. In some disclosed examples, the method comprises implementing, via a controller of a grill, a cook program to cook an item of food within a cooking chamber of the grill. In some disclosed examples, the cooking chamber is defined by a cookbox and a lid of the grill. In some disclosed examples, the lid is movable relative to the cookbox between a closed position and an open position. In some disclosed examples, the cooking chamber is accessible to a user of the grill when the lid is in the open position. In some disclosed examples, the cook program includes a plurality of ordered steps, with the plurality of ordered steps including a lid-opening step requiring the lid to be moved from the closed position to the open position. In some disclosed examples, the method further comprises determining, via the controller and based on lid position data, whether the lid-opening step has been performed. In some disclosed examples, the method further comprises, in response to determining that the lid-opening step has been performed, automatically advancing, via the controller, the plurality of ordered steps from the lid-opening step to a next step of the plurality of ordered steps.

In some disclosed examples, automatically advancing the plurality of ordered steps from the lid-opening step to the next step occurs based on the lid position data and without the grill separately receiving a user input instructing the controller to advance the plurality of ordered steps from the lid-opening step to the next step.

In some disclosed examples, automatically advancing the plurality of ordered steps from the lid-opening step to the next step occurs based on the lid position data and without the grill separately receiving a user input indicating that the lid-opening step has been performed.

In some disclosed examples, the method further comprises detecting the lid position data via a lid position sensor of the grill. In some disclosed examples, the lid position sensor is in electrical communication with the controller.

In some disclosed examples, the lid position sensor is a contact sensor.

In some disclosed examples, the lid position sensor is a proximity sensor.

In some disclosed examples, the lid position sensor is an accelerometer.

In some disclosed examples, the method further comprises detecting temperature data via a temperature sensor of the grill. In some disclosed examples, the temperature sensor is in electrical communication with the controller. In some disclosed examples, the temperature data indicates a temperature within the cooking chamber. In some disclosed examples, the method further comprises deriving, via the controller, the lid position data from the temperature data.

In some disclosed examples, the lid-opening step requires the lid to be moved from the closed position to the open position in association with adding the item of food to the cooking chamber or removing the item of food from the cooking chamber.

In some disclosed examples, the lid-opening step requires the lid to be moved from the closed position to the open position in association with flipping, rotating, or relocating the item of food within the cooking chamber.

In some disclosed examples, the lid-opening step requires the lid to be moved from the closed position to the open position in association with a startup process that involves igniting one or more burners of the grill.

In some examples, a non-transitory computer-readable medium is disclosed. In some disclosed examples, the non-transitory computer-readable medium comprises computer-readable instructions. In some disclosed examples, the computer-readable instructions, when executed, cause one or more processors of a grill to implement a cook program to cook an item of food within a cooking chamber of the grill. In some disclosed examples, the cooking chamber is defined by a cookbox and a lid of the grill. In some disclosed examples, the lid is movable relative to the cookbox between a closed position and an open position. In some disclosed examples, the cooking chamber is accessible to a user of the grill when the lid is in the open position. In some disclosed examples, the cook program includes a plurality of ordered steps, with the plurality of ordered steps including a lid-opening step requiring the lid to be moved from the closed position to the open position. In some disclosed examples, the computer-readable instructions, when executed, further cause the one or more processors to determine, based on lid position data, whether the lid-opening step has been performed. In some disclosed examples, the computer-readable instructions, when executed, further cause the one or more processors, in response to determining that the lid-opening step has been performed, to automatically advance the plurality of ordered steps from the lid-opening step to a next step of the plurality of ordered steps.

In some disclosed examples, the computer-readable instructions, when executed, cause the one or more processors to automatically advance the plurality of ordered steps from the lid-opening step to the next step based on the lid position data and without the grill separately receiving a user input instructing the one or more processors to advance the plurality of ordered steps from the lid-opening step to the next step.

In some disclosed examples, the computer-readable instructions, when executed, cause the one or more processors to automatically advance the plurality of ordered steps from the lid-opening step to the next step based on the lid position data and without the grill separately receiving a user input indicating that the lid-opening step has been performed.

In some disclosed examples, the lid position data is detected via a lid position sensor of the grill. In some disclosed examples, the lid position sensor is in electrical communication with the one or more processors.

In some disclosed examples, the lid position sensor is a contact sensor.

In some disclosed examples, the lid position sensor is a proximity sensor.

In some disclosed examples, the lid position sensor is an accelerometer.

In some disclosed examples, the computer-readable instructions, when executed, cause the one or more processors to derive the lid position data from temperature data detected via a temperature sensor of the grill. In some disclosed examples, the temperature sensor is in electrical communication with the one or more processors. In some disclosed examples, the temperature data indicates a temperature within the cooking chamber.

In some disclosed examples, the lid-opening step requires the lid to be moved from the closed position to the open position in association with adding the item of food to the cooking chamber or removing the item of food from the cooking chamber.

In some disclosed examples, the lid-opening step requires the lid to be moved from the closed position to the open position in association with flipping, rotating, or relocating the item of food within the cooking chamber.

In some disclosed examples, the lid-opening step requires the lid to be moved from the closed position to the open position in association with a startup process that involves igniting one or more burners of the grill.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. A grill, comprising:
a cookbox;
a lid movable relative to the cookbox between a closed position and an open position;
a cooking chamber defined by the cookbox and the lid, the cooking chamber accessible to a user of the grill when the lid is in the open position;
a controller to:
implement a cook program to cook an item of food within the cooking chamber, the cook program including a plurality of ordered steps, the plurality of ordered steps including a lid-opening step requiring the lid to be moved from the closed position to the open position;
determine, based on lid position data, whether the lid-opening step has been performed; and
in response to determining that the lid-opening step has been performed, automatically advance the plurality of ordered steps from the lid-opening step to a next step of the plurality of ordered steps.

2. The grill of claim 1, wherein the controller is to automatically advance the plurality of ordered steps from the lid-opening step to the next step based on the lid position data and without the grill separately receiving a user input instructing the controller to advance the plurality of ordered steps from the lid-opening step to the next step.

3. The grill of claim 1, wherein the controller is to automatically advance the plurality of ordered steps from the lid-opening step to the next step based on the lid position data and without the grill separately receiving a user input indicating that the lid-opening step has been performed.

4. The grill of claim 1, further comprising a lid position sensor in electrical communication with the controller, wherein the lid position data is detected via the lid position sensor.

5. The grill of claim 4, wherein the lid position sensor is a contact sensor.

6. The grill of claim 4, wherein the lid position sensor is a proximity sensor.

7. The grill of claim 4, wherein the lid position sensor is an accelerometer.

8. The grill of claim 1, further comprising a temperature sensor in electrical communication with the controller, the temperature sensor to detect temperature data indicating a temperature within the cooking chamber, the controller to derive the lid position data from the temperature data.

9. The grill of claim 1, wherein the lid-opening step requires the lid to be moved from the closed position to the open position in association with adding the item of food to the cooking chamber or removing the item of food from the cooking chamber.

10. The grill of claim 1, wherein the lid-opening step requires the lid to be moved from the closed position to the open position in association with flipping, rotating, or relocating the item of food within the cooking chamber.

11. The grill of claim 1, wherein the lid-opening step requires the lid to be moved from the closed position to the open position in association with a startup process that involves igniting one or more burners of the grill.

12. A method, comprising:
implementing, via a controller of a grill, a cook program to cook an item of food within a cooking chamber of the grill, the cooking chamber defined by a cookbox and a lid of the grill, the lid movable relative to the cookbox between a closed position and an open position, the cooking chamber accessible to a user of the grill when the lid is in the open position, the cook program including a plurality of ordered steps, the plurality of ordered steps including a lid-opening step requiring the lid to be moved from the closed position to the open position;
determining, via the controller and based on lid position data, whether the lid-opening step has been performed; and
in response to determining that the lid-opening step has been performed, automatically advancing, via the controller, the plurality of ordered steps from the lid-opening step to a next step of the plurality of ordered steps.

13. The method of claim 12, wherein automatically advancing the plurality of ordered steps from the lid-opening step to the next step occurs based on the lid position data and without the grill separately receiving a user input instructing the controller to advance the plurality of ordered steps from the lid-opening step to the next step.

14. The method of claim 12, wherein automatically advancing the plurality of ordered steps from the lid-opening step to the next step occurs based on the lid position data and without the grill separately receiving a user input indicating that the lid-opening step has been performed.

15-16. (canceled)

17. The method of claim 12, further comprising:
detecting temperature data via a temperature sensor of the grill, the temperature sensor in electrical communication with the controller, the temperature data indicating a temperature within the cooking chamber; and
deriving, via the controller, the lid position data from the temperature data.

18. The method of claim 12, wherein the lid-opening step requires the lid to be moved from the closed position to the open position in association with adding the item of food to the cooking chamber or removing the item of food from the cooking chamber, in association with flipping, rotating, or relocating the item of food within the cooking chamber, or in association with a startup process that involves igniting one or more burners of the grill.

19. A non-transitory computer-readable medium comprising computer-readable instructions that, when executed, cause one or more processors of a grill to at least:
implement a cook program to cook an item of food within a cooking chamber of the grill, the cooking chamber defined by a cookbox and a lid of the grill, the lid movable relative to the cookbox between a closed position and an open position, the cooking chamber accessible to a user of the grill when the lid is in the open position, the cook program including a plurality of ordered steps, the plurality of ordered steps including a lid-opening step requiring the lid to be moved from the closed position to the open position;
determine, based on lid position data, whether the lid-opening step has been performed; and
in response to determining that the lid-opening step has been performed, automatically advance the plurality of ordered steps from the lid-opening step to a next step of the plurality of ordered steps.

20. The non-transitory computer-readable medium of claim 19, wherein the computer-readable instructions, when executed, cause the one or more processors to automatically advance the plurality of ordered steps from the lid-opening step to the next step based on the lid position data and without the grill separately receiving a user input instructing the one or more processors to advance the plurality of ordered steps from the lid-opening step to the next step.

21. The non-transitory computer-readable medium of claim 19, wherein the computer-readable instructions, when executed, cause the one or more processors to automatically advance the plurality of ordered steps from the lid-opening step to the next step based on the lid position data and without the grill separately receiving a user input indicating that the lid-opening step has been performed.

22-23. (canceled)

24. The non-transitory computer-readable medium of claim 19, wherein the computer-readable instructions, when executed, cause the one or more processors to derive the lid position data from temperature data detected via a temperature sensor of the grill, the temperature sensor in electrical communication with the one or more processors, the temperature data indicating a temperature within the cooking chamber.

25. (canceled)
